(19) United States
(12) Patent Application Publication
(10) Pub. No.: US 2023/0262730 A1
(43) Pub. Date: Aug. 17, 2023

(54) AVOIDANCE OF HALF DUPLEX LOSS IN SIDELINK COMMUNICATION

(71) Applicant: QUALCOMM Incorporated, San Diego, CA (US)

(72) Inventors: Tien Viet NGUYEN, Bridgewater, NJ (US); Gabi SARKIS, San Diego, CA (US); Sourjya DUTTA, San Diego, CA (US); Shuanshuan WU, San Diego, CA (US)

(21) Appl. No.: 18/159,551

(22) Filed: Jan. 25, 2023

Related U.S. Application Data
(60) Provisional application No. 63/267,991, filed on Feb. 14, 2022.

(51) Int. Cl. H04W 72/25

(52) U.S. Cl. CPC H04W 72/25; H04W 72/0446

(57) ABSTRACT

Various aspects of the present disclosure generally relate to wireless communication. In some aspects, a first user equipment (UE) may receive, from a second UE, an inter-UE coordination message comprising an indication of a first sidelink resource, of a set of sidelink resources, corresponding to a transmission by the second UE. The UE may transmit a sidelink communication using a second sidelink resource, of a subset of candidate sidelink resources of a set of candidate resources, based at least in part on the indication of the first sidelink resource and a communication relationship between the first UE and the second UE. Numerous other aspects are described.

### CROSS-REFERENCE TO RELATED APPLICATION

This Patent application claims priority to U.S. Provisional Patent Application No. 63/267,991, filed on Feb. 14, 2022, entitled “AVOIDANCE OF HALF DUPLEX LOSS IN SIDELINK COMMUNICATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for avoidance of half duplex loss in sidelink communication.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a first user equipment (UE). The method may include receiving, from a second UE, an inter-UE coordination (IUC) message comprising an indication of a first sidelink resource, of a set of sidelink resources, corresponding to a transmission by the second UE, wherein the first sidelink resource is associated with a first subset of the set of sidelink resources, wherein the first subset comprises a set of non-preferred resources, and wherein a second subset of the set of sidelink resources comprises a set of candidate resources. The method may include transmitting a sidelink communication using a second sidelink resource, of a subset of candidate resources of the set of candidate resources, wherein the subset of candidate resources is based at least in part on the indication of the first sidelink resource and a communication relationship between the first UE and the second UE.

Some aspects described herein relate to a method of wireless communication performed by a first UE. The method may include receiving, from a second UE, an indication communication comprising, a first sidelink resource indication that indicates a first sidelink resource, of a set of sidelink resources, corresponding to a transmission by the second UE, where the first sidelink resource is associated with a first subset of the set of sidelink resources, where the first subset comprises a set of non-preferred resources, and where a second subset of the set of sidelink resources comprises a set of candidate resources a second sidelink resource indication that indicates the first sidelink resource. The method may include transmitting a sidelink communication using a second sidelink resource, of a subset of candidate resources of the set of candidate resources, wherein the subset of candidate resources is based at least in part on the indication communication and a communication relationship between the first UE and the second UE.

Some aspects described herein relate to a method of wireless communication performed by a first UE. The method may include receiving, from a second UE, an IUC message comprising a first sidelink resource indication that indicates a first sidelink resource, of a set of sidelink resources, corresponding to a transmission by the second UE, wherein the first sidelink resource is associated with a first subset of the set of sidelink resources, wherein the first subset comprises a set of non-preferred resources, and wherein a second subset of the set of sidelink resources comprises a set of candidate resources. The method may include receiving, from the second UE, a sidelink control communication comprising a second sidelink resource indication that indicates at least one of a slot associated with the first sidelink resource or a first subchannel associated with the first sidelink resource. The method may include transmitting a sidelink communication using a second sidelink resource, of a subset of candidate resources of the set of candidate resources, wherein the subset of candidate resources is based at least in part on the first sidelink resource indication and a communication relationship between the first UE and the second UE.

Some aspects described herein relate to a method of wireless communication performed by a first UE. The method may include determining a first sidelink resource, of a set of sidelink resources, corresponding to a transmission by the first UE. The method may include transmitting, to a second UE, an IUC message comprising an indication of the first sidelink resource, wherein the first sidelink resource is associated with a first subset of the set of sidelink resources, wherein the first subset comprises a set of non-preferred resources.

Some aspects described herein relate to a method of wireless communication performed by a first UE. The method may include determining a first sidelink resource, of a set of sidelink resources, corresponding to a transmission by the first UE. The method may include transmitting an indication communication comprising, a first sidelink resource indication that indicates the first sidelink resource a second sidelink resource indication that indicates the first sidelink resource, where the first sidelink resource is associated with a first subset of the set of sidelink resources, where the first subset comprises a set of non-preferred resources.

Some aspects described herein relate to a method of wireless communication performed by a first UE. The method may include determining a first sidelink resource, of a set of sidelink resources, corresponding to a transmission by the first UE. The method may include transmitting, to a second UE, an IUC message comprising a first sidelink resource indication that indicates the first sidelink resource, wherein the first sidelink resource is associated with a first subset of the set of sidelink resources, wherein the first subset comprises a set of non-preferred resources. The method may include transmitting, to the second UE, a sidelink control communication comprising a second sidelink resource indication that indicates at least one of a slot associated with the first sidelink resource or a first subchannel associated with the first sidelink resource.

Some aspects described herein relate to a first UE for wireless communication. The first user equipment may include a memory and one or more processors coupled to the memory. The one or more processors may be configured to receive, from a second UE, an IUC message comprising an indication of a first sidelink resource, of a set of sidelink resources, corresponding to a transmission by the second UE, wherein the first sidelink resource is associated with a first subset of the set of sidelink resources, wherein the first subset comprises a set of non-preferred resources, and wherein a second subset of the set of sidelink resources comprises a set of candidate resources. The one or more processors may be configured to transmit a sidelink communication using a second sidelink resource, of a subset of candidate resources of the set of candidate resources, wherein the subset of candidate resources is based at least in part on the indication of the first sidelink resource and a communication relationship between the first UE and the second UE.

Some aspects described herein relate to a first UE for wireless communication. The first user equipment may include a memory and one or more processors coupled to the memory. The one or more processors may be configured to receive, from a second UE, an indication communication comprising. The one or more processors may be configured to transmit a sidelink communication using a second sidelink resource, of a subset of candidate resources of the set of candidate resources, wherein the subset of candidate resources is based at least in part on the indication communication and a communication relationship between the first UE and the second UE.

Some aspects described herein relate to a first UE for wireless communication. The first user equipment may include a memory and one or more processors coupled to the memory. The one or more processors may be configured to receive, from a second UE, an IUC message comprising a first sidelink resource indication that indicates a first sidelink resource, of a set of sidelink resources, corresponding to a transmission by the second UE, wherein the first sidelink resource is associated with a first subset of the set of sidelink resources, wherein the first subset comprises a set of non-preferred resources, and wherein a second subset of the set of sidelink resources comprises a set of candidate resources. The one or more processors may be configured to receive, from the second UE, a sidelink control communication comprising a second sidelink resource indication that indicates at least one of a slot associated with the first sidelink resource or a first subchannel associated with the first sidelink resource. The one or more processors may be configured to transmit a sidelink communication using a second sidelink resource, of a subset of candidate resources of the set of candidate resources, wherein the subset of candidate resources is based at least in part on the first sidelink resource indication and a communication relationship between the first UE and the second UE.

Some aspects described herein relate to a first UE for wireless communication. The first user equipment may include a memory and one or more processors coupled to the memory. The one or more processors may be configured to determine a first sidelink resource, of a set of sidelink resources, corresponding to a transmission by the first UE. The one or more processors may be configured to transmit, to a second UE, an IUC message comprising an indication of the first sidelink resource, wherein the first sidelink resource is associated with a first subset of the set of sidelink resources, wherein the first subset comprises a set of non-preferred resources.

Some aspects described herein relate to a first UE for wireless communication. The first user equipment may include a memory and one or more processors coupled to the memory. The one or more processors may be configured to determine a first sidelink resource, of a set of sidelink resources, corresponding to a transmission by the first UE. The one or more processors may be configured to transmit an indication communication comprising a first sidelink resource indication that indicates the first sidelink resource; and a second sidelink resource indication that indicates the first sidelink resource, wherein the first sidelink resource is associated with a first subset of the set of sidelink resources, wherein the first subset comprises a set of non-preferred resources.

Some aspects described herein relate to a first UE for wireless communication. The first user equipment may include a memory and one or more processors coupled to the memory. The one or more processors may be configured to determine a first sidelink resource, of a set of sidelink resources, corresponding to a transmission by the first UE. The one or more processors may be configured to transmit, to a second UE, an IUC message comprising a first sidelink resource indication that indicates the first sidelink resource, wherein the first sidelink resource is associated with a first subset of the set of sidelink resources, wherein the first subset comprises a set of non-preferred resources. The one or more processors may be configured to transmit, to the second UE, a sidelink control communication comprising a second sidelink resource indication that indicates at least one of a slot associated with the first sidelink resource or a first subchannel associated with the first sidelink resource.

Some aspects described herein relate to a non-transitory computer-readable medium that stores a set of instructions for wireless communication by a first UE. The set of instructions, when executed by one or more processors of the UE, may cause the UE to receive, from a second UE, an IUC message comprising an indication of a first sidelink resource, of a set of sidelink resources, corresponding to a transmission by the second UE, wherein the first sidelink resource is associated with a first subset of the set of sidelink resources, wherein the first subset comprises a set of non-preferred resources, and wherein a second subset of the set of sidelink resources comprises a set of candidate resources. The set of instructions, when executed by one or more processors of the UE, may cause the UE to transmit a sidelink communication using a second sidelink resource, of a subset of candidate resources of the set of candidate resources, wherein the subset of candidate resources is based at least in part on the indication of the first sidelink resource and a communication relationship between the first UE and the second UE.

Some aspects described herein relate to a non-transitory computer-readable medium that stores a set of instructions for wireless communication by an UE. The set of instructions, when executed by one or more processors of the UE, may cause the UE to receive, from a second UE, an indication communication comprising. The set of instructions, when executed by one or more processors of the UE, may cause the UE to transmit a sidelink communication using a second sidelink resource, of a subset of candidate resources of the set of candidate resources, wherein the subset of candidate resources is based at least in part on the indication communication and a communication relationship between the first UE and the second UE.

Some aspects described herein relate to a non-transitory computer-readable medium that stores a set of instructions for wireless communication by an UE. The set of instructions, when executed by one or more processors of the UE, may cause the UE to receive, from a second UE, an IUC message comprising a first sidelink resource indication that indicates a first sidelink resource, of a set of sidelink resources, corresponding to a transmission by the second UE, wherein the first sidelink resource is associated with a first subset of the set of sidelink resources, wherein the first subset comprises a set of non-preferred resources, and wherein a second subset of the set of sidelink resources comprises a set of candidate resources. The set of instructions, when executed by one or more processors of the UE, may cause the UE to receive, from the second UE, a sidelink control communication comprising a second sidelink resource indication that indicates at least one of a slot associated with the first sidelink resource or a first subchannel associated with the first sidelink resource. The set of instructions, when executed by one or more processors of the UE, may cause the UE to transmit a sidelink communication using a second sidelink resource, of a subset of candidate resources of the set of candidate resources, wherein the subset of candidate resources is based at least in part on the first sidelink resource indication and a communication relationship between the first UE and the second UE.

Some aspects described herein relate to a non-transitory computer-readable medium that stores a set of instructions for wireless communication by an UE. The set of instructions, when executed by one or more processors of the UE, may cause the UE to determine a first sidelink resource, of a set of sidelink resources, corresponding to a transmission by the first UE. The set of instructions, when executed by one or more processors of the UE, may cause the UE to transmit, to a second UE, an IUC message comprising an indication of the first sidelink resource, wherein the first sidelink resource is associated with a first subset of the set of sidelink resources, wherein the first subset comprises a set of non-preferred resources.

Some aspects described herein relate to a non-transitory computer-readable medium that stores a set of instructions for wireless communication by an UE. The set of instructions, when executed by one or more processors of the UE, may cause the UE to determine a first sidelink resource, of a set of sidelink resources, corresponding to a transmission by the first UE. The set of instructions, when executed by one or more processors of the UE, may cause the UE to transmit an indication communication comprising a first sidelink resource indication that indicates the first sidelink resource; and a second sidelink resource indication that indicates the first sidelink resource, wherein the first sidelink resource is associated with a first subset of the set of sidelink resources, wherein the first subset comprises a set of non-preferred resources.

Some aspects described herein relate to a non-transitory computer-readable medium that stores a set of instructions for wireless communication by an UE. The set of instructions, when executed by one or more processors of the UE, may cause the UE to determine a first sidelink resource, of a set of sidelink resources, corresponding to a transmission by the first UE. The set of instructions, when executed by one or more processors of the UE, may cause the UE to transmit, to a second UE, an IUC message comprising a first sidelink resource indication that indicates the first sidelink resource, wherein the first sidelink resource is associated with a first subset of the set of sidelink resources, wherein the first subset comprises a set of non-preferred resources. The set of instructions, when executed by one or more processors of the UE, may cause the UE to transmit, to the second UE, a sidelink control communication comprising a second sidelink resource indication that indicates at least one of a slot associated with the first sidelink resource or a first subchannel associated with the first sidelink resource.

Some aspects described herein relate to an apparatus for wireless communication. The apparatus may include means for receiving, from a UE, an IUC message comprising an indication of a first sidelink resource, of a set of sidelink resources, corresponding to a transmission by the UE, wherein the first sidelink resource is associated with a first subset of the set of sidelink resources, wherein the first subset comprises a set of non-preferred resources, and wherein a second subset of the set of sidelink resources comprises a set of candidate resources. The apparatus may include means for transmitting a sidelink communication using a second sidelink resource, of a subset of candidate resources of the set of candidate resources, wherein the subset of candidate resources is based at least in part on the indication of the first sidelink resource and a communication relationship between the apparatus and the UE.

Some aspects described herein relate to an apparatus for wireless communication. The apparatus may include means for receiving, from a UE, an indication communication comprising, a first sidelink resource indication that indicates a first sidelink resource, of a set of sidelink resources, corresponding to a transmission by the UE, where the first sidelink resource is associated with a first subset of the set of sidelink resources, where the first subset comprises a set of non-preferred resources, and where a second subset of the set of sidelink resources comprises a set of candidate resources a second sidelink resource indication that indicates the first sidelink resource. The apparatus may include means for transmitting a sidelink communication using a second sidelink resource, of a subset of candidate resources of the set of candidate resources, wherein the subset of candidate resources is based at least in part on the indication communication and a communication relationship between the apparatus and the UE.

Some aspects described herein relate to an apparatus for wireless communication. The apparatus may include means for receiving, from a UE, an IUC message comprising a first sidelink resource indication that indicates a first sidelink resource, of a set of sidelink resources, corresponding to a transmission by the UE, wherein the first sidelink resource is associated with a first subset of the set of sidelink resources, wherein the first subset comprises a set of non-preferred resources, and wherein a second subset of the set of sidelink resources comprises a set of candidate resources. The apparatus may include means for receiving, from the UE, a sidelink control communication comprising a second sidelink resource indication that indicates at least one of a slot associated with the first sidelink resource or a first subchannel associated with the first sidelink resource. The apparatus may include means for transmitting a sidelink communication using a second sidelink resource, of a subset of candidate resources of the set of candidate resources, wherein the subset of candidate resources is based at least in part on the first sidelink resource indication and a communication relationship between the apparatus and the UE.

Some aspects described herein relate to an apparatus for wireless communication. The apparatus may include means for determining a first sidelink resource, of a set of sidelink resources, corresponding to a transmission by the apparatus. The apparatus may include means for transmitting, to a UE, an IUC message comprising an indication of the first sidelink resource, wherein the first sidelink resource is associated with a first subset of the set of sidelink resources, wherein the first subset comprises a set of non-preferred resources.

Some aspects described herein relate to an apparatus for wireless communication. The apparatus may include means for determining a first sidelink resource, of a set of sidelink resources, corresponding to a transmission by the apparatus. The apparatus may include means for transmitting an indication communication comprising, a first sidelink resource indication that indicates the first sidelink resource a second sidelink resource indication that indicates the first sidelink resource, where the first sidelink resource is associated with a first subset of the set of sidelink resources, where the first subset comprises a set of non-preferred resources.

Some aspects described herein relate to an apparatus for wireless communication. The apparatus may include means for determining a first sidelink resource, of a set of sidelink resources, corresponding to a transmission by the apparatus. The apparatus may include means for transmitting, to a UE, an IUC message comprising a first sidelink resource indication that indicates the first sidelink resource, wherein the first sidelink resource is associated with a first subset of the set of sidelink resources, wherein the first subset comprises a set of non-preferred resources. The apparatus may include means for transmitting, to the UE, a sidelink control communication comprising a second sidelink resource indication that indicates at least one of a slot associated with the first sidelink resource or a first subchannel associated with the first sidelink resource.

Aspects generally include a method, apparatus, system, computer program product, non-transitory computer-readable medium, user equipment, base station, network node, wireless communication device, and/or processing system as substantially described herein with reference to and as illustrated by the drawings, specification, and appendix.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIGS. 4 and 5 are diagrams illustrating examples associated with avoidance of half duplex loss in sidelink communication, in accordance with the present disclosure.

FIGS. 6-11 are diagrams illustrating example processes associated with avoidance of half duplex loss in sidelink communication, in accordance with the present disclosure.

FIG. 12 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

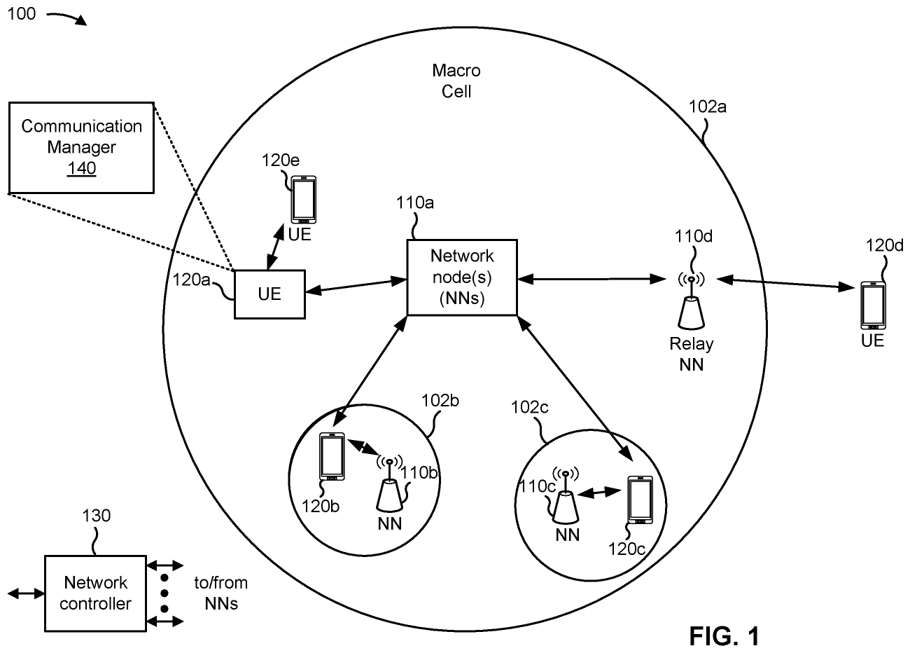

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a NN 110a, a NN 110b, a NN 110c, and a NN 110d), a user equipment (UE) 120 or multiple UEs 120 (shown as a UE 120a, a UE 120b, a UE 120c, a UE 120d, and a UE 120e), and/or other network entities. A network node 110 is an entity that communicates with UEs 120. A network node 110 (sometimes referred to as a BS) may include, for example, an NR base station, an LTE base station, a Node B, an eNB (e.g., in 4G), a gNB (e.g., in 5G), an access point, and/or a transmission reception point (TRP). Each network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used.

A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the NN 110a may be a macro network node for a macro cell 102a, the NN 110b may be a pico network node for a pico cell 102b, and the NN 110c may be a femto network node for a femto cell 102c. A network node may support one or multiple (e.g., three) cells.

In some examples, a cell may not necessarily be stationary, and the geographic area of the cell may move according to the location of a network node 110 that is mobile (e.g., a mobile network node). In some examples, the network nodes 110 may be interconnected to one another and/or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a network node 110 or a UE 120) and send a transmission of the data to a downstream station (e.g., a UE 120 or a network node 110). A relay station may be a UE 120 that can relay transmissions for other UEs 120. In the example shown in FIG. 1, the NN 110d (e.g., a relay network node) may communicate with the NN 110a (e.g., a macro network node) and the UE 120d in order to facilitate communication between the NN 110a and the UE 120d. A network node 110 that relays communications may be referred to as a relay station, a relay network node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

As described herein, a network node, which may be referred to as a “node,” a “network node,” or a “wireless node,” may be a base station (e.g., base station 110), a UE (e.g., UE 120), a relay device, a network controller, an apparatus, a device, a computing system, one or more components of any of these, and/or another processing entity configured to perform one or more aspects of the techniques described herein. For example, a network node may be a UE. As another example, a network node may be a base station. A network node may be an aggregated base station and/or one or more components of a disaggregated base station. As an example, a first network node may be configured to communicate with a second network node or a third network node. The adjectives “first,” “second,” “third,” and so on are used for contextual distinction between two or more of the modified noun in connection with a discussion and are not meant to be absolute modifiers that apply only to a certain respective node throughout the entire document. For example, a network node may be referred to as a “first network node” in connection with one discussion and may be referred to as a “second network node” in connection with another discussion, or vice versa. Reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses a first network node being configured to receive information from a second network node, “first network node” may refer to a first UE, a first base station, a first apparatus, a first device, a first computing system, a first one or more components, a first processing entity, or the like configured to receive the information from the second network; and “second network node” may refer to a second UE, a second base station, a second apparatus, a second device, a second computing system, a second one or more components, a second processing entity, or the like.

In some aspects, a UE (e.g., the UE 120) may include a communication manager 140. As described in more detail elsewhere herein, the communication manager 140 may receive, from a second UE, an inter-UE coordination (IUC) message comprising an indication of a first sidelink resource, of a set of sidelink resources, corresponding to a transmission by the second UE, wherein the first sidelink resource is associated with a first subset of the set of sidelink resources, wherein the first subset comprises a set of non-preferred resources, and wherein a second subset of the set of sidelink resources comprises a set of candidate resources; and transmit a sidelink communication using a second sidelink resource, of a subset of candidate resources of the set of candidate resources, wherein the subset of candidate resources is based at least in part on the indication of the first sidelink resource and a communication relationship between the first UE and the second UE.

As described in more detail elsewhere herein, the communication manager 140 may receive, from a second UE, an indication communication comprising: a first sidelink resource indication that indicates a first sidelink resource, of a set of sidelink resources, corresponding to a transmission by the second UE, wherein the first sidelink resource is associated with a first subset of the set of sidelink resources, wherein the first subset comprises a set of non-preferred resources, and wherein a second subset of the set of sidelink resources comprises a set of candidate resources; and a second sidelink resource indication that indicates the first sidelink resource; and transmit a sidelink communication using a second sidelink resource, of a subset of candidate resources of the set of candidate resources, wherein the subset of candidate resources is based at least in part on the indication communication and a communication relationship between the first UE and the second UE.

As described in more detail elsewhere herein, the communication manager 140 may receive, from a second UE, an IUC message comprising a first sidelink resource indication that indicates a first sidelink resource, of a set of sidelink resources, corresponding to a transmission by the second UE, wherein the first sidelink resource is associated with a first subset of the set of sidelink resources, wherein the first subset comprises a set of non-preferred resources, and wherein a second subset of the set of sidelink resources comprises a set of candidate resources; receive, from the second UE, a sidelink control communication comprising a second sidelink resource indication that indicates at least one of a slot associated with the first sidelink resource or a first subchannel associated with the first sidelink resource; and transmit a sidelink communication using a second sidelink resource, of a subset of candidate resources of the set of candidate resources, wherein the subset of candidate resources is based at least in part on the first sidelink resource indication and a communication relationship between the first UE and the second UE.

As described in more detail elsewhere herein, the communication manager 140 may determine a first sidelink resource, of a set of sidelink resources, corresponding to a transmission by the first UE; and transmit, to a second UE, an IUC message comprising an indication of the first sidelink resource, wherein the first sidelink resource is associated with a first subset of the set of sidelink resources, wherein the first subset comprises a set of non-preferred resources.

As described in more detail elsewhere herein, the communication manager 140 may determine a first sidelink resource, of a set of sidelink resources, corresponding to a transmission by the first UE; and transmit an indication communication comprising: a first sidelink resource indication that indicates the first sidelink resource; and a second sidelink resource indication that indicates the first sidelink resource, wherein the first sidelink resource is associated with a first subset of the set of sidelink resources, wherein the first subset comprises a set of non-preferred resources.

As described in more detail elsewhere herein, the communication manager 140 may determine a first sidelink resource, of a set of sidelink resources, corresponding to a transmission by the first UE; transmit, to a second UE, an IUC message comprising a first sidelink resource indication that indicates the first sidelink resource, wherein the first sidelink resource is associated with a first subset of the set of sidelink resources, wherein the first subset comprises a set of non-preferred resources; and transmit, to the second UE, a sidelink control communication comprising a second sidelink resource indication that indicates at least one of a slot associated with the first sidelink resource or a first subchannel associated with the first sidelink resource. Additionally, or alternatively, the communication manager 140 may perform one or more other operations described herein.

As indicated above, FIG. 1 is provided as an example. Other examples may differ from what is described with regard to FIG. 1.

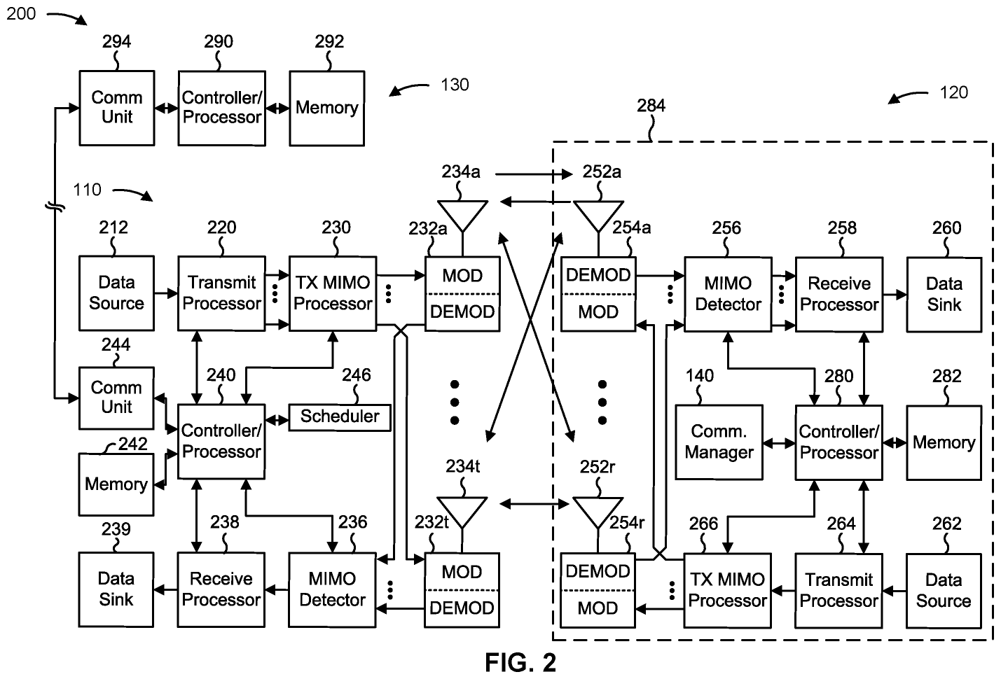

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1).

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

In some aspects, the term “network node” (e.g., the network node 110), “base station,” or “network entity” may refer to an aggregated base station, a disaggregated base station, an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) MC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a network node, such as for millimeter wave communications and/or the like. In such a case, the network node may provide the UE with a configuration of transmission configuration indicator (TCI) states that respectively indicate beams that may be used by the UE, such as for receiving a physical downlink shared channel (PDSCH). The network node may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a quasi-co-location (QCL) type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-CSI-RS-ResourceId, an SSB Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

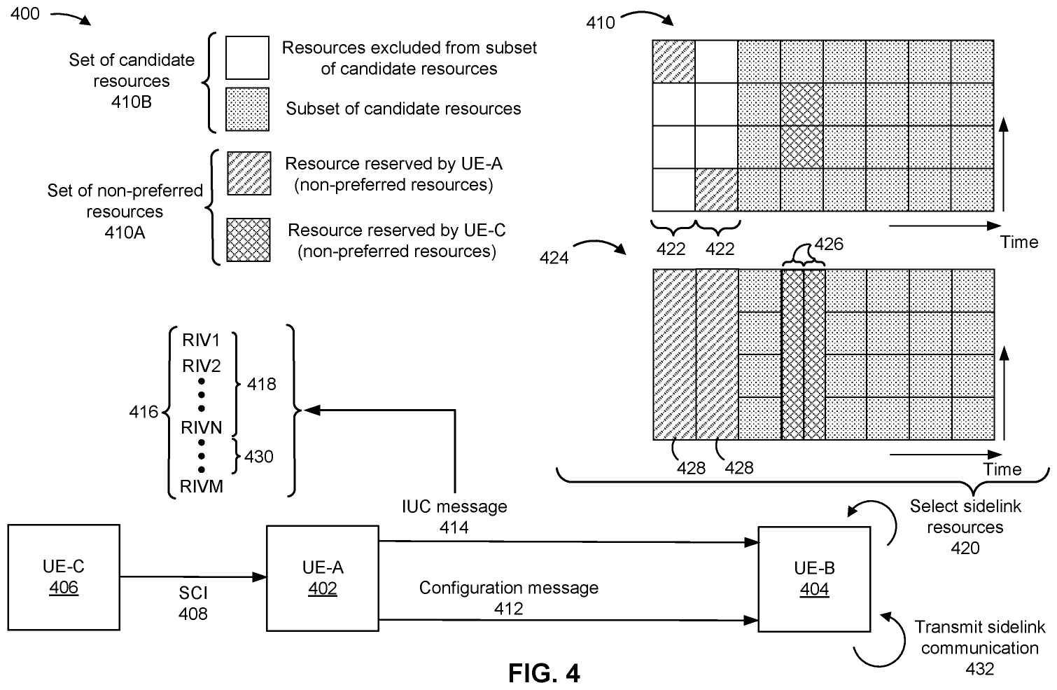

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-12).

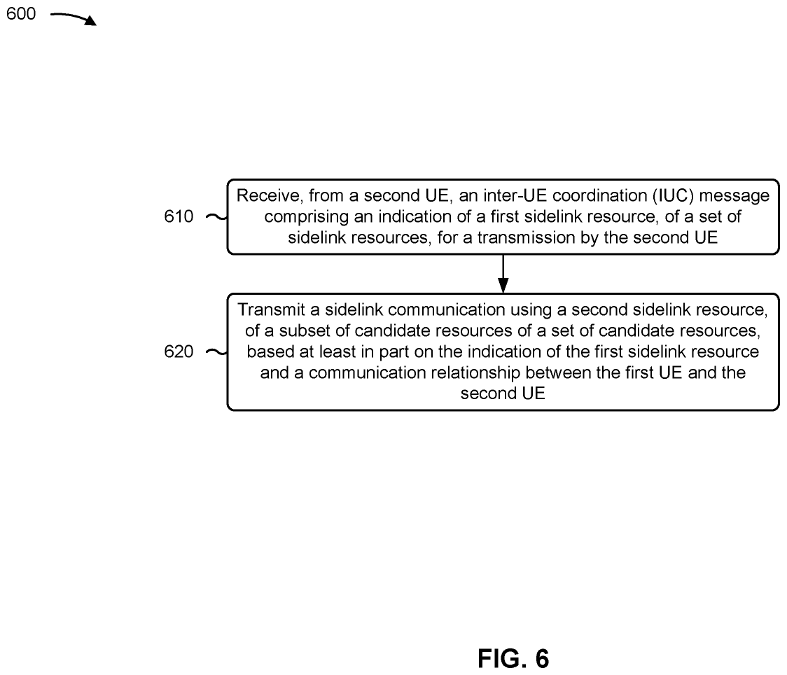

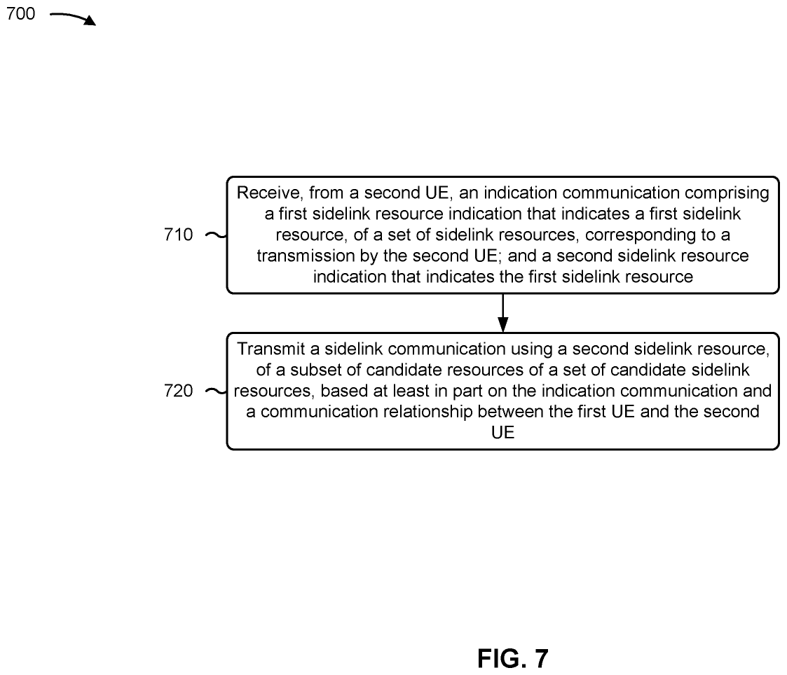

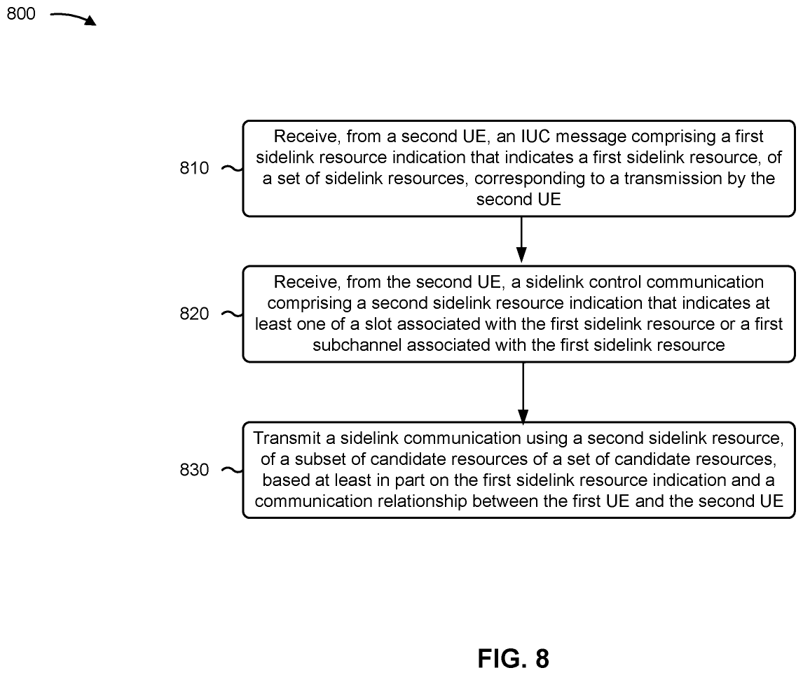

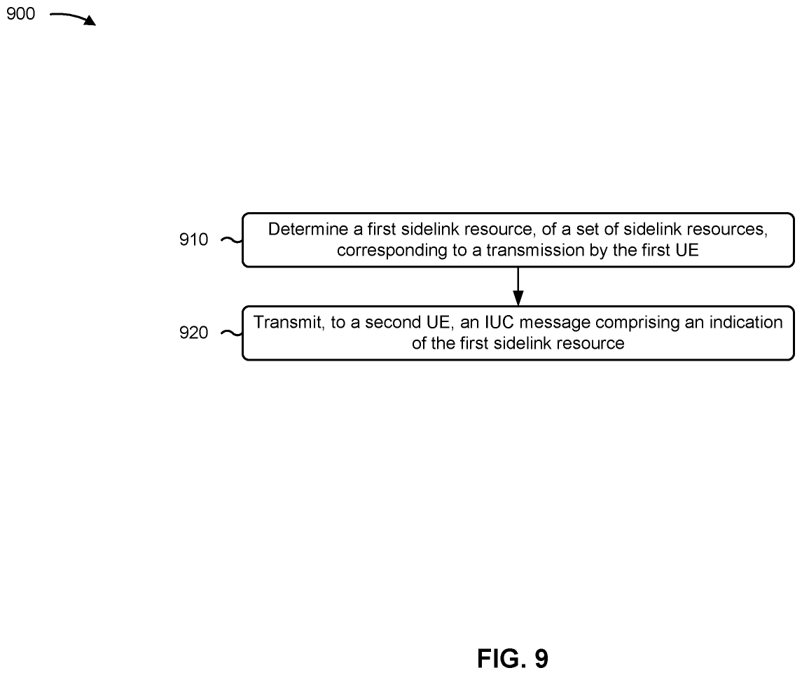

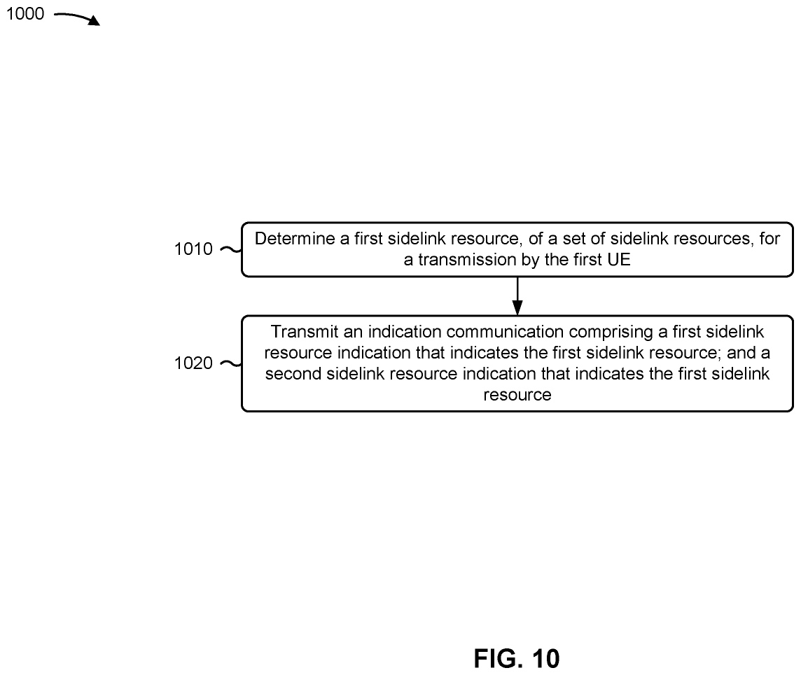

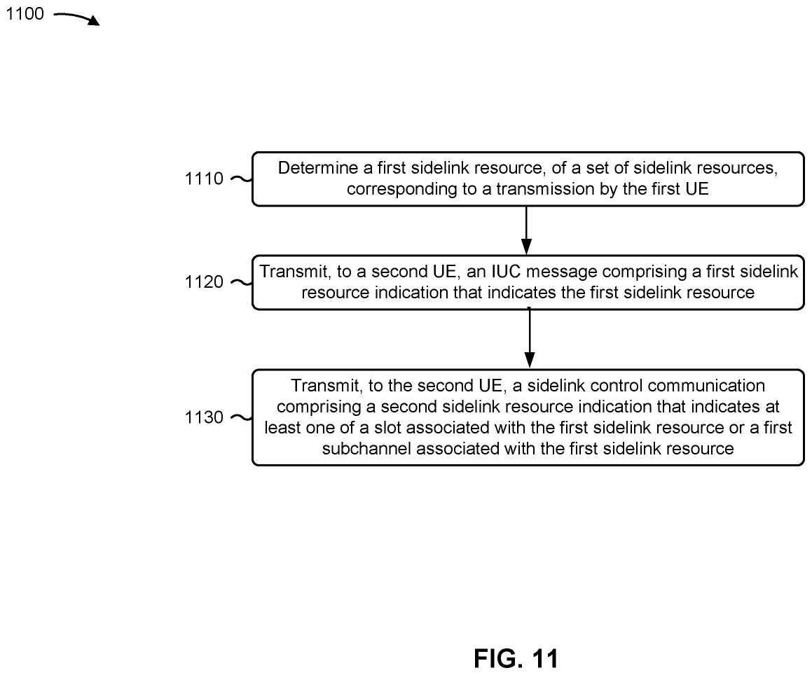

The controller/processor 240 of the network node 110, the controller/processor 280 of the UE 120, and/or any other component(s) of FIG. 2 may perform one or more techniques associated with avoidance of half duplex loss in sidelink communication, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, process 800 of FIG. 8, process 900 of FIG. 9, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, process 800 of FIG. 8, process 900 of FIG. 9, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, a first UE includes means for receiving, from a second UE, an IUC message comprising an indication of a first sidelink resource, of a set of sidelink resources, corresponding to a transmission by the second UE, wherein the first sidelink resource is associated with a first subset of the set of sidelink resources, wherein the first subset comprises a set of non-preferred resources, and wherein a second subset of the set of sidelink resources comprises a set of candidate resources; and means for transmitting a sidelink communication using a second sidelink resource, of a subset of candidate resources of the set of candidate resources, wherein the subset of candidate resources is based at least in part on the indication of the first sidelink resource and a communication relationship between the first UE and the second UE.

In some aspects, the first UE includes means for receiving, from a second UE, an indication communication comprising: a first sidelink resource indication that indicates a first sidelink resource, of a set of sidelink resources, corresponding to a transmission by the second UE, wherein the first sidelink resource is associated with a first subset of the set of sidelink resources, wherein the first subset comprises a set of non-preferred resources, and wherein a second subset of the set of sidelink resources comprises a set of candidate resources; and a second sidelink resource indication that indicates the first sidelink resource; and means for transmitting a sidelink communication using a second sidelink resource, of a subset of candidate resources of the set of candidate resources, wherein the subset of candidate resources is based at least in part on the indication communication and a communication relationship between the first UE and the second UE.

In some aspects, the first UE includes means for receiving, from a second UE, an IUC message comprising a first sidelink resource indication that indicates a first sidelink resource, of a set of sidelink resources, corresponding to a transmission by the second UE, wherein the first sidelink resource is associated with a first subset of the set of sidelink resources, wherein the first subset comprises a set of non-preferred resources, and wherein a second subset of the set of sidelink resources comprises a set of candidate resources; means for receiving, from the second UE, a sidelink control communication comprising a second sidelink resource indication that indicates at least one of a slot associated with the first sidelink resource or a first subchannel associated with the first sidelink resource; and means for transmitting a sidelink communication using a second sidelink resource, of a subset of candidate resources of the set of candidate resources, wherein the subset of candidate resources is based at least in part on the first sidelink resource indication and a communication relationship between the first UE and the second UE.

In some aspects, the first UE includes means for determining a first sidelink resource, of a set of sidelink resources, corresponding to a transmission by the first UE; and means for transmitting, to a second UE, an IUC message comprising an indication of the first sidelink resource, wherein the first sidelink resource is associated with a first subset of the set of sidelink resources, wherein the first subset comprises a set of non-preferred resources.

In some aspects, the first UE includes means for determining a first sidelink resource, of a set of sidelink resources, corresponding to a transmission by the first UE; and means for transmitting an indication communication comprising: a first sidelink resource indication that indicates the first sidelink resource; and a second sidelink resource indication that indicates the first sidelink resource, wherein the first sidelink resource is associated with a first subset of the set of sidelink resources, wherein the first subset comprises a set of non-preferred resources.

In some aspects, the first UE includes means for determining a first sidelink resource, of a set of sidelink resources, corresponding to a transmission by the first UE; means for transmitting, to a second UE, an IUC message comprising a first sidelink resource indication that indicates the first sidelink resource, wherein the first sidelink resource is associated with a first subset of the set of sidelink resources, wherein the first subset comprises a set of non-preferred resources; and means for transmitting, to the second UE, a sidelink control communication comprising a second sidelink resource indication that indicates at least one of a slot associated with the first sidelink resource or a first subchannel associated with the first sidelink resource. The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

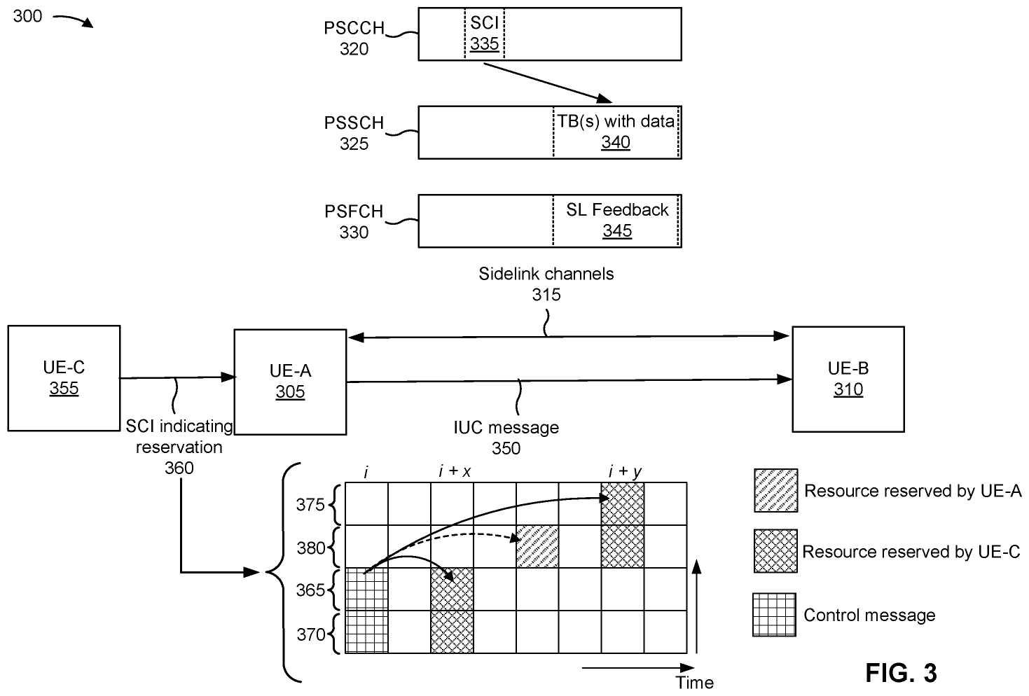

FIG. 3 is a diagram illustrating an example 300 of sidelink communications, in accordance with the present disclosure.

As shown in FIG. 3, a first UE 305 (shown as “UE-A”) can communicate with a second UE 310 (shown as “UE-B”) via one or more sidelink channels 315. In some cases, the UE-A 305 and/or the UE-B 310 can communicate with any number of other UEs. The UEs 305 and 310 can communicate using the one or more sidelink channels 315 for P2P communications, D2D communications, V2X communications (e.g., which may include V2V communications, V2I communications, and/or V2P communications) and/or mesh networking. In some aspects, one or more of the UEs 305 and 310 may be, be similar to, include, or be included in, the UE 120 depicted in FIGS. 1 and 2. In some aspects, the one or more sidelink channels 315 can use a PC5 interface and/or operate in a high frequency band (e.g., the 5.9 GHz band). Additionally, or alternatively, the UEs 305 and/or 310 can synchronize timing of transmission time intervals (TTIs) (e.g., frames, subframes, slots, or symbols) using global navigation satellite system (GNSS) timing.

As further shown in FIG. 3, the one or more sidelink channels 315 can include a physical sidelink control channel (PSCCH) 320, a physical sidelink shared channel (PSSCH) 325, and/or a physical sidelink feedback channel (PSFCH) 330. The PSCCH 320 can be used to communicate control information, similar to a physical downlink control channel (PDCCH) and/or a physical uplink control channel (PUCCH) used for cellular communications with a network node 110 via an access link or an access channel. The PSSCH 325 can be used to communicate data, similar to a PDSCH and/or a physical uplink shared channel (PUSCH) used for cellular communications with a network node 110 via an access link or an access channel. For example, the PSCCH 320 can carry sidelink control information (SCI) 335, which can indicate various control information used for sidelink communications, such as one or more resources (e.g., time resources, frequency resources, and/or spatial resources) where a transport block (TB) 340 can be carried on the PSSCH 325. The SCI 335 may be transmitted in a same slot as the TB 340. The TB 340 may include data. The PSFCH 330 can be used to communicate sidelink feedback 345, such as hybrid automatic repeat request (HARD) feedback (e.g., ACK/NACK information), transmit power control (TPC), and/or a scheduling request (SR). A retransmission of the data in the TB 340 may be indicated by the SCI 335.

Although shown on the PSCCH 320, in some aspects, the SCI 335 can include multiple communications in different stages, such as a first stage SCI (SCI-1) communication and a second stage SCI (SCI-2) communication. The SCI-1 communication can be transmitted on the PSCCH 320. The SCI-2 communication can be transmitted on the PSSCH 325. The SCI-1 communication can include, for example, an indication of one or more resources (e.g., time resources, frequency resources, and/or spatial resources) on the PSSCH 325, information for decoding sidelink communications on the PSSCH, a quality of service (QoS) priority value, a resource reservation period, a PSSCH DMRS pattern, an SCI format for the SCI-2 communication, a beta offset for the SCI-2 communication, a quantity of PSSCH DMRS ports, and/or a MCS. The SCI-2 communication can include information associated with data transmissions on the PSSCH 325, such as a HARQ process ID, a new data indicator (NDI), a source identifier, a destination identifier, and/or a channel state information (CSI) report trigger.

In some aspects, the one or more sidelink channels 315 can use resource pools. For example, a scheduling assignment (e.g., included in SCI 335) can be transmitted in sub-channels using specific resource blocks (RBs) across time. In some aspects, data transmissions (e.g., on the PSSCH 325) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 and/or 310 can operate using a first sidelink transmission mode (e.g., Mode 1) where resource selection and/or scheduling is performed by a network node (e.g., the network node 110 depicted in FIGS. 1 and 2). For example, the UE 305 and/or 310 can receive a grant (e.g., in DCI or in a radio resource control (RRC) message, such as for configured grants) from the network node for sidelink channel access and/or scheduling. In some aspects, a UE 305 and/or 310 can operate using a second transmission mode (e.g., Mode 2) where resource selection and/or scheduling is performed by the UE 305 and/or 310 (e.g., rather than by a network node). In some aspects, the 305 and/or 310 can perform resource selection and/or scheduling by sensing channel availability for transmissions. For example, the UE 305 and/or 310 can measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 and/or 310 can perform resource selection and/or scheduling using SCI 335 received in the PSCCH 320, which can indicate occupied resources and/or channel parameters. Additionally, or alternatively, the UE 305 and/or 310 can perform resource selection and/or scheduling by determining a channel busy ratio (CBR) associated with various sidelink channels, which can be used for rate control (e.g., by indicating a maximum number of resource blocks that the UE 305 and/or 310 can use for a particular set of subframes).

In the second transmission mode, the UE 305 and/or 310 can generate sidelink grants, and can transmit the grants in SCI 335. A sidelink grant can indicate, for example, one or more parameters (e.g., transmission parameters) to be used for an upcoming sidelink transmission, such as one or more resource blocks to be used for the upcoming sidelink transmission on the PSSCH 325 (e.g., for TBs 340), and/or one or more subframes to be used for the upcoming sidelink transmission. In some aspects, a UE 305 and/or 310 can generate a sidelink grant that indicates one or more parameters for semi-persistent scheduling (SPS), such as a periodicity of a sidelink transmission. Additionally, or alternatively, the UE 305 and/or 310 can generate a sidelink grant for event-driven scheduling, such as for an on-demand sidelink message.

In some cases, inter-UE coordination may be implemented to improve reliability and efficiency. In the case of the second transmission mode operations, each transmitting UE can perform a sensing operation to find occupied and/or available resources to utilize for an upcoming transmission. For example, UEs participating in sidelink communications can share resource information (e.g., a reservation received from other UEs in the system) indicating time and frequency resources reserved for one or more future transmissions. In some cases, for example, inter-UE coordination in the second transmission mode of sidelink communications can be specified according to an inter-UE coordination scheme in which a first UE (e.g., the UE-A 305) transmits an IUC message 350 to a second UE (e.g., the UE-B 310). The IUC message 350 is a message that indicates coordination information. The coordination information can include a set of preferred resources (e.g., a set of resources preferred for a transmission by the UE-B 310) and/or a set of non-preferred resources (e.g., a set of resources that are not preferred for the transmission by the UE-B 310). In some cases, the IUC message can include additional coordination information. The UE-B 310 can use the coordination information for resource selection and/or re-selection.

In the inter-UE coordination scheme, the reserved resources can be included in the set of non-preferred resources due to multiple conditions. In the first condition, the reserved resource can be included in the set of non-preferred resources based at least in part on one or more reserved resources of one or more other UEs (e.g., the UE-C 355) being identified by the UE-A 305 whose RSRP measurement is larger than a configured (or pre-configured) RSRP threshold which is determined by at least a priority value indicated by SCI of the one or more other UEs. In a second condition, the reserved resources can be included in the set of non-preferred resources based at least in part on one or more reserved resources of one or more other UEs being identified by the UE-A 305 whose RSRP measurement is smaller than a configured (or pre-configured) RSRP threshold which is determined by at least a priority value indicated by SCI of the one or more other UEs when the UE-A 305 is a destination of a TB transmitted by the one or more other UEs.

In another case, the reserved resource can be included in the set of non-preferred resources based at least in part on identification of one or more resources (e.g., one or more slots) where UE-A, when it is an intended receiver of UE-B (e.g., when the UE-A 305 is a receiving UE of a transmission from the UE-B 310), does not expect to perform sidelink reception from the UE-B 310 due to half duplex operation.

In some cases, the inter-UE coordination information can be multiplexed with other data if the source/destination ID pair is the same. Retransmission of the TB carrying inter-UE coordination information also can be supported.

In some cases, a resource pool level configuration (or pre-configuration) can enable a number of alternatives. For example, a medium access control (MAC) control element (MAC CE) and/or a second stage SCI communication can be used as an IUC message for transmitting inter-UE coordination message from the UE-A 305 to the UE-B 310. Resource indication values can be used to indicate the resource set. For example, in the first alternative, N combinations of time resource indication values (TRIVs), frequency resource indication values (FRIVs), and resource reservation periods can be indicated. The value of a resource reservation period can be omitted at least when the transmission of a preferred resource set is triggered by an explicit request from the UE-B 310. A first resource location of each TRIV can be separately indicated by the inter-UE coordination information. For example, if N<=3, a MAC CE and/or a second stage SCI communication can be used. When both the MAC CE and the second stage SIC communication are used, the same resource set can be indicated in the second stage SCI communication and the MAC CE. In some examples, if N>3, only the MAC CE can be used. In some cases, the UE-A 305 can determine whether the second stage SCI communication is to be used in combination with the MAC CE.

For example, in some aspects, the IUC message 350 can include resource indication values (RIVs) to indicate reserved resources associated with a UE-C 355. As shown by reference number 360, for example, the UE-C 355 can transmit an SCI message indicating one or more resource reservations to the UE-A 305. The UE-A 305 can include a reserved resource in the set of non-preferred resources conveyed by IUC message 350. The SCI message can indicate one or more resources reserved by the UE-C 355. In some cases, an RIV can include a TRIV or an FRIV. In some cases, for example, a TRIV can be used to indicate a time resource offset from a control message to a sidelink resource that is indicated as being reserved in the control message. In some aspects, for example, the RIVs can be indicated in an SCI message. In some aspects, the RIVs can be indicated in an SCI message and the IUC message 350. In some aspects, the RIVs can be indicated in an IUC message 350.

As shown, for example, a control message (e.g., the IUC message 350) transmitted in a slot i can indicate a first time resource (e.g., slot), i+x, associated with a first reserved sidelink resource, where x is a first time offset from the slot i. The control message can indicate a second time resource, i+y, associated with a second reserved sidelink resource, where y is a second time offset from the slot i. An FRIV can be used to indicate a first subchannel associated with each resource reservation. For example, a first FRIV can indicate a first subchannel 365 of two subchannels 365 and 370 associated with the first reservation at i+x, and a second FRIV can indicate a first subchannel 375 of two subchannels 375 and 380 associated with the second reservation at i+y. In some cases, RIVs can be signaled in an ordered list.

The inter-UE information signaling concepts described above, however, do not address half duplex loss in sidelink. For example, the UE-A 305 can reserve a sidelink resource for transmission to the UE-B 310 and without a mechanism for indicating the reserved resource, the UE-B 310 can select a resource that overlaps the reserved resource in a time domain. However, if the UE-B 310 is configured for half duplex communications instead of full duplex communications, one of the communications (e.g., the transmission to the UE-B 310 or the transmission from the UE-B 310) may be lost (e.g., not transmitted or received), thereby having a negative impact on network performance.

In some cases, a solution can include changing a MAC CE design to signal the reserved resource. However, in other cases, the MAC CE design can be left unchanged, in which case another mechanism for indicating the reserved resource must be found. One potential solution would be to include the resource reserved for transmission in the set of non-preferred resources to be sent in IUC message. While this helps in avoiding collision, it does not fully address the half duplex issue since the resource can be in the same slot but not overlapping with the selected subchannel. Another solution can be to include the reserved resource for transmission as a full bandwidth resource (or resources) in the set of non-preferred resource(s) to be sent in IUC message. While this helps in avoiding half duplex, it can lead to over-exclusion, since all the other UEs on the sidelink network may avoid selecting available resources from the slot.

Some aspects of the techniques and apparatuses described herein may provide for indicating a reserved resource in an IUC message, in combination with specified receiving UE behaviors that facilitate avoidance of half duplex loss, while also avoiding (or mitigating) over-exclusion of sidelink resources. In some aspects, for example, a first UE (e.g., the UE-A 305) may transmit, and a second UE (e.g., the UE-B 310) may receive, an IUC message (e.g., the IUC message 350 shown in FIG. 3) that includes an indication of a first resource reserved by the first UE for a transmission to the second UE. In some aspects, for example, a rule may indicate that an indicated resource is the resource reserved for transmission from the first UE based at least in part on a characteristic of the indication thereof. In this way, the second UE may identify resources reserved for transmissions from the first UE to the second UE and, accordingly, avoid selecting corresponding resources for transmissions from the second UE. Accordingly, some aspects may facilitate avoiding half duplex loss, resulting in a decrease in missed communications and thereby have a positive impact on network performance.

As indicated above, FIG. 3 is provided as an example. Other examples may differ from what is described with respect to FIG. 3.

FIG. 4 is a diagram illustrating an example 400 associated with avoidance of half duplex loss in sidelink communication, in accordance with the present disclosure. As shown, a UE-A 402 and a UE-B 404 may communicate with one another. A UE-C 406 also may communicate with the UE-A 402 and/or the UE-B 404. In some aspects, the UE-A 402 may be, be similar to, include, or be included in the UE-A 305 depicted in FIG. 3. Similarly, the UE-B 404 may be, be similar to, include, or be included in the UE-B 310 depicted in FIG. 3. The UE-C 406 may be, be similar to, include, or be included in, the UE-C 355 depicted in FIG. 3.

As shown by reference number 408, the UE-C 406 may transmit SCI to reserve resources for the UE-C 406 transmission to the UE-A 402. The SCI may indicate one or more sidelink resources, of a set 410 of sidelink resources, reserved by the UE-C 406. As shown by reference number 412, the UE-A 402 may transmit, and the UE-B 404 may receive, a configuration message. The configuration message may configure any number of parameters, sidelink schemes, signaling behaviors, and/or the like. In some aspects, the configuration message may include multiple transmitted messages. In some aspects, the UE-B 404 may receive the configuration message from a different entity such as, for example, a network node (e.g., a network node and/or relay device, among other examples). In some aspects, the configuration message may include an RRC configuration, a MAC CE configuration, and/or an SCI configuration, among other examples. The UE-A 402 also may receive one or more aspects of the configuration (e.g., from a network node).

In some aspects, the configuration message may configure an IUC scheme in which the UE-A 402 includes indications of resources reserved by the UE-A 402 in an IUC message. In some aspects, for example, the configuration message may configure a number of resource indication values in a first subset of resource indication values of an ordered list of resource indication values, where resource indication values of the first subset of resource indication values are configured to indicate resources associated with a transmission by the UE-A 402. In some aspects, the configuration message may indicate activation of a configuration of at least one bit of an SCI message to be used as an indication of a number of resource indication values in a first subset of resource indication values. In some aspects, the configuration message may include a configuration parameter having a first value or a second value. The first value may indicate that the set of sidelink resources is a set of preferred sidelink resources, and the second value may indicate that the set of sidelink resources is a set of non-preferred sidelink resources.

As shown by reference number 414, the UE-A 402 may transmit, and the UE-B 404 may receive, an IUC message. The IUC message may include an indication of a first sidelink resource, of the set 410 of sidelink resources, corresponding to a transmission by the UE-A 402. The first sidelink resource may be associated with a first subset of the set of sidelink resources. The first subset may include a set 410A of non-preferred resources. A second subset of the set 410 of sidelink resources may include a set 410B of candidate resources. In some aspects, the indication of the first sidelink resource comprises a specified resource indication value of an ordered set 416 of resource indication values. The ordered set 416 of resource indication values may include at least one of a TRIV or an FRIV. In some aspects, the specified resource indication value corresponds to a first subset 418 of resource indication values in the ordered set 416 of resource indication values. In some aspects, the specified resource indication value may include a full-bandwidth indication value corresponding to an entire available bandwidth in a reserved time resource.

In some aspects, a number, N, of resource indication values in the first subset 418 of resource indication values may be specified by a wireless communication standard. In some aspects, as indicated above, the UE-B 404 may receive a configuration message that configures a number of resource indication values in the first subset of resource indication values. In some aspects, the UE-B 404 may receive (e.g., from the UE-A 402) a first stage sidelink control information message that includes an indication of a number of resource indication values in the first subset 418 of resource indication values. In some aspects, the indication of the number of resource indication values in the first subset of resource indication values may include at least one reserved bit. The at least one reserved bit may include only one bit, and the configuration message may indicate activation of a configuration of the at least one reserved bit to be used as the indication of the number of resource indication values in the first subset of resource indication values.

As shown by reference number 420, the UE-B 404 may select sidelink resources for a transmission from the UE-B 404. In some aspects, for example, the UE-B 404 may determine the second subset (the set 410B of candidate resources) of the set of sidelink resources. The set 410B of candidate resources may include, for example, sidelink resources, of the set 410 of sidelink resources, that are not non-preferred resources. The non-preferred resources may include the sidelink resources, of the set 410 of sidelink resources, that are reserved by the UE-A 402 and/or the UE-C 406. In some aspects, the UE-B 404 may be a receiving UE of the transmission associated with the indicated reserved resource by the UE-A 402. In this case, in some aspects, a subset of candidate resources, from which the UE-B 404 selects a second sidelink resource for transmission, may exclude resources corresponding to one or more slots 422 associated with the first sidelink resource based at least in part on the UE-B 404 being a receiver UE of the transmission by the UE-A 402, as shown in connection with the set 410 of sidelink resources. In some aspects, the UE-B 404 is not a receiving UE of the transmission by the UE-A 402. In that case, the subset of candidate sidelink resources may be the set 410B of candidate sidelink resources.

As shown in FIG. 4, in another example in connection with a set 424 of sidelink resources, the ordered set 416 of resource indication values may include an indication of a full-slot sidelink resource 426 reserved by the UE-C 406. Because the UE-B 404 may not be able to differentiate between an indication of a full-slot sidelink resource 426 associated with a reservation by the UE-C 406 and an indication of a full-slot sidelink resource 428 associated with a reservation by the UE-A 402, the indication of the full-slot sidelink resource 426 may include an indication of two half-slot reserved sidelink resources, as shown in FIG. 4.

In some aspects, a specified resource indication value of an ordered set 416 of resource indication values may correspond to a first subset 418 of resource indication values of the ordered set 416 of resource indication values. The ordered set of resource indication values may include an indication of the full-slot sidelink resource 426 reserved by the UE-C 406. In some aspects, the indication of the full-slot sidelink resource 426 may be included in a second subset 430 of resource indication values of the ordered set 416 of resource indication values. In some aspects, the indication of the full-slot sidelink resource 426 may include a resource indication value following a first non-full-slot resource indication value.

As shown by reference number 432, the UE-B 404 may transmit a sidelink communication using the second (selected) resource.

In some aspects, the UE-A 402 may include an indication of the first resource in a set of resources to be indicated in the IUC message. For example, the set of resources to be indicated in the IUC message may be the set 410A of non-preferred resources. The UE-A 402 may also transmit a first stage SCI communication that includes an indication of one or more slots associated with the first resource and a first subchannel associated with the first resource. In this way, UEs in the sidelink network other than the UE-B 404 may be able to avoid selecting the first resource, and the UE-B 404 may be able to avoid selecting any resource in the associated slots so as to avoid loss of half duplex. In some aspects, some UEs that are not configured to support the reception of the IUC message may still be informed of at least the first subchannel associated with the first resource and be able to avoid selecting resources in that subchannel.

In some aspects, the UE-A 402 may include an indication of the first resource in a set of resources (e.g., the set 410A of non-preferred resources) indicated in the IUC message. The UE-A 402 also may transmit a second stage SCI communication that includes an indication of the one or more associated slots. In this way, UEs in the sidelink network other than the UE-B 404 may be able to avoid selecting the first resource, and the UE-B 404 may be able to avoid selecting any resource in the associated slots so as to avoid loss of half duplex. In some aspects, the indication of the one or more slots in the second stage SCI communication may include one or more dedicated fields. In some aspects, by indicating the slots in the second stage SCI communication, many reserved resources may be indicated. In some aspects, the UE-A 402 may also indicate a slot in which the UE-A 402 may be transmitting in other channels.

As explained above, a first resource for a transmission by the UE-A 402 may be included in a set (e.g., the set 410A of non-preferred resources) of resources to be sent in an IUC message. The first resource may be indicated, for example, using a first subset of resource indication values. Based at least in part on receiving the IUC message, the UE-B 404 may avoid the full slot signaled in the first N TRIVs if the UE-B 404 is a receiving UE of the transmission of UE-A 402 corresponding to the reserved resource. If the UE-B 404 is not a receiving UE of the transmission from the UE-A 402, the UE-B 404 may ignore the reserved resource indication, or only exclude the reserved resources.

For example, the indication of the first sidelink resource may include a full-bandwidth indication corresponding to an entire available bandwidth in a reserved time resource associated with the first sidelink resource. If the UE-B 404 is a receiving UE of the transmission by the UE-A 402, the subset of candidate sidelink resources may exclude all resources corresponding to the reserved time resource (e.g., the slots 422). If the UE-B 404 is not a receiver UE of the transmission by the UE-A 402, the subset of candidate sidelink resources may be the set 410B of candidate sidelink resources.

In some other aspects, the first resource may be indicated as a full bandwidth resource in the set of resources to be sent in the IUC message. In some aspects, if the UE-B 404 is a receiving UE of transmission from UE-A 402, the UE-B 404 may avoid selecting any resources from the full slot signaled in the first up to N TRIVs that indicate full slot resources. In these aspects, no new signaling may be required, as the indication may be signaled as a full-slot resource. Thus, half duplex loss may be mitigating without additional overhead.

In some aspects, there may not be, from the UE-B 404 perspective, a difference between an indication of a reserved resource corresponding to a transmission from the UE-A 402 to the UE-B 404 and a reserved resource corresponding to a transmission to another UE (e.g., UE-C 406). In some aspects, this may be addressed by configuration. For example, the UE-B 404 (and/or any other UE on the sidelink network) may be configured to never use a full bandwidth resource allocation. In some aspects, the UE-A 402 may be configured to indicate full bandwidth resources associated with a receiving UE other than the UE-B 404 by indicating such a slot indication using two half-slot indications, as discussed above. In some aspects, the UE-A 402 may be configured to indicate any reserved resources not intended for receipt by UE-B 404 after the first N resource indication values and/or after the first non-full slot resource indication value.

As indicated above, FIG. 4 is provided as an example. Other examples may differ from what is described with respect to FIG. 4.

In some aspects, a rule may specify that, if a resource is indicated twice in a MAC CE or a second stage SCI communication, then the resource is a reserved resource associated with a transmission from the UE-A 305 to the UE-B 310. In some aspects, the rule may specify that the indicated resource is a reserved resource associated with a transmission from the UE-A 305 to the UE-B 310 if one indication is a non-full slot indication and the other indication is a full slot indication

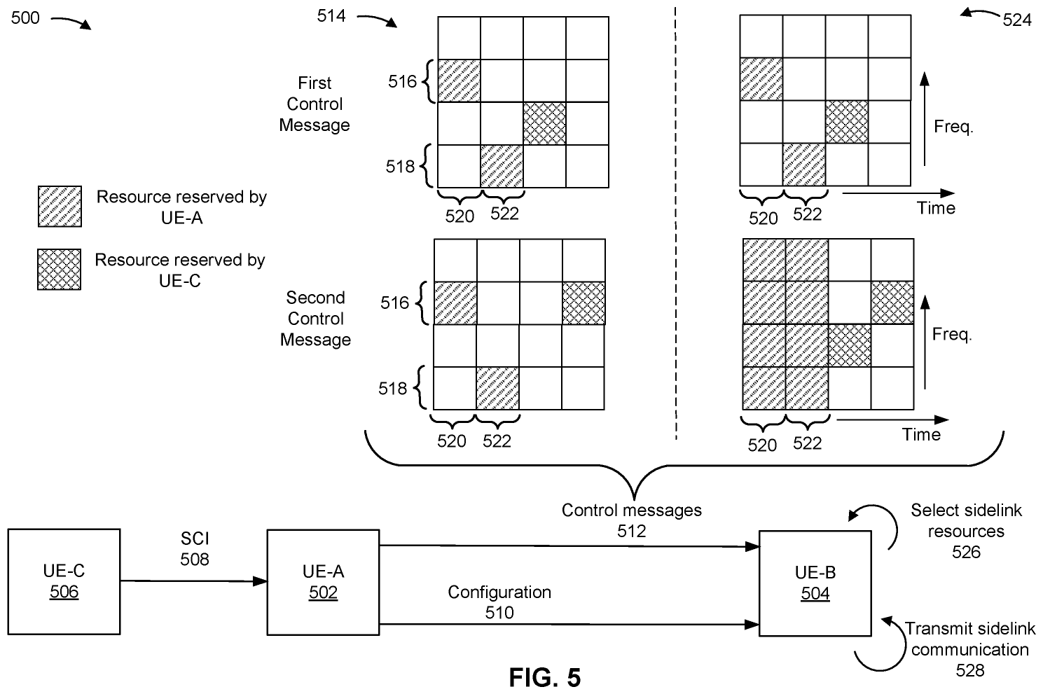

FIG. 5 is a diagram illustrating an example 500 associated with avoidance of half duplex loss in sidelink communication, in accordance with the present disclosure. As shown, a UE-A 502 and a UE-B 504 may communicate with one another. A UE-C 506 also may communicate with the UE-A 502 and/or the UE-B 504. In some aspects, the UE-A 502 may be, be similar to, include, or be included in the UE-A 402 depicted in FIG. 4. Similarly, the UE-B 504 may be, be similar to, include, or be included in the UE-B 404 depicted in FIG. 4. The UE-C 506 may be, be similar to, include, or be included in, the UE-C 406 depicted in FIG. 4.

As shown by reference number 508, the UE-C 506 may transmit SCI to the UE-A 502. The SCI may indicate one or more sidelink resources, of a set of sidelink resources, reserved by the UE-C 506. As shown by reference number 510, the UE-A 502 may transmit, and the UE-B 504 may receive, a configuration message, as explained above in connection with FIG. 4. The configuration message may configure any number of parameters, sidelink schemes, signaling behaviors, and/or the like. In some aspects, the configuration message may include multiple transmitted messages. In some aspects, the UE-B 504 may receive the configuration message from a different entity such as, for example, a network node (e.g., a network node and/or relay device, among other examples). In some aspects, the configuration message may include an RRC configuration, a MAC CE configuration, and/or an SCI configuration, among other examples. The UE-A 502 also may receive one or more aspects of the configuration (e.g., from a network node).

As shown by reference number 512, the UE-A 502 may transmit, and the UE-B 504 may receive, control messages. The control messages may include an IUC message, a first stage SCI message, and/or a second stage SCI message, among other examples. As shown, for example, the control messages may include a first control message that indicates reserved resources. The reserved resources may include resources reserved for transmission by the UE-A 502 and resources reserved for transmission by the UE-C 506. The UE-B 504 may distinguish between the two types of reservations based at least in part on a second signaling of the resources. For example, in some aspects, the UE-A 502 may include, in the first control message or, as shown, in a second control message, a second indication of the resources reserved for the transmission by the UE-A 502.

In some aspects, as shown by reference number 514, for example, the UE-B 504 may determine the resources reserved for the transmission by the UE-A 502 based at least in part on determining reserved resources that are indicated for the same starting subchannel 516 and 518, respectively. In some aspects, the UE-B 504 may determine the resources based at least in part determining reserved resources that are indicated for the same slots 520 and 522, respectively. In some aspects, the UE-A 502 may be configured to indicate the reserved resources in a first control message and then to indicate full-slot resources corresponding to the reserved resources in a second control message. As shown by reference number 524, in some aspects, the UE-B 504 may determine the resources reserved for the transmission by the UE-A 502 based at least in part on determining full-slot resources indicated by the second control message in association with the same slots 520 and 522 that were indicated by the first control message as corresponding to reserved resources.

As shown by reference number 526, the UE-B 504 may select sidelink resources for a transmission from the UE-B 504. In some aspects, the UE-B 504 may be a receiving UE of the transmission associated with the indicated reserved resource by the UE-A 502. In this case, in some aspects, a subset of candidate sidelink resources, from which the UE-B 504 selects sidelink resources for transmission, may exclude resources corresponding to one or more slots 520 and 522 associated with the reserved sidelink resource based at least in part on the UE-B 504 being a receiver UE of the transmission by the UE-A 502. In some aspects, the UE-B 504 is not a receiving UE of the transmission by the UE-A 502. In that case, the subset of candidate sidelink resources may exclude only the reserved sidelink resource or may include the entire set of sidelink resources. As shown by reference number 528, the UE-B 504 may transmit a sidelink communication using the selected resource.

As indicated above, FIG. 5 is provided as an example. Other examples may differ from what is described with respect to FIG. 5.

In some aspects, one or more of the aspects described above in connection with FIGS. 4 and 5 may be used only when the IUC message is not multiplexed with data. If the IUC message is multiplexed with data, the UE-B may be configured to avoid selecting resources for transmission from a slot signaled in a corresponding first stage SCI communication. In some aspects, one or more of the aspects described above may be used only when the IUC message is a unicast message. In some aspects, an RRC configuration parameter for toggling activation of a configuration associated with a preferred set of resources may be used to toggle activation, in connection with non-preferred resources, of a scheme such as one of the schemes described above.

FIG. 6 is a diagram illustrating an example process 600 performed, for example, by a first UE, in accordance with the present disclosure. Example process 600 is an example where the UE (e.g., UE-B 404) performs operations associated with avoidance of half duplex loss in sidelink communication.

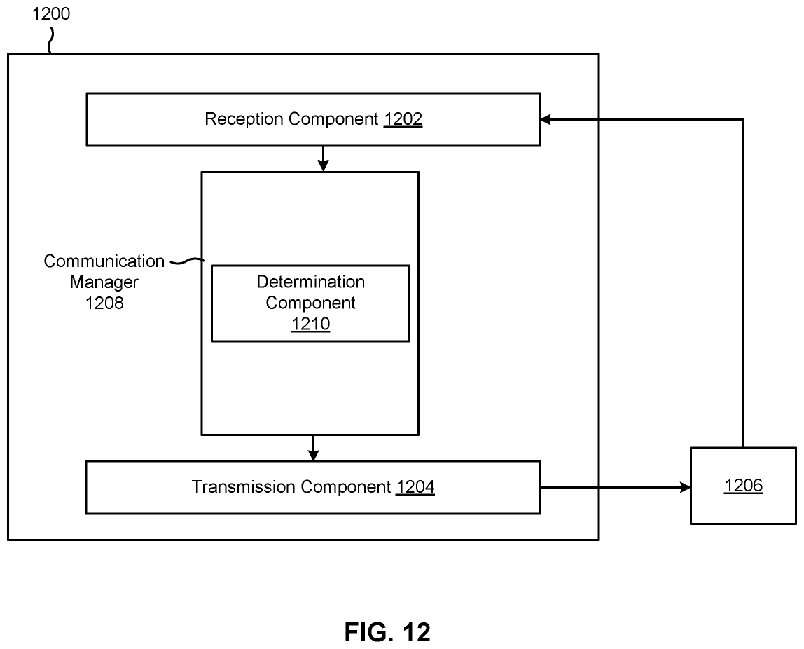

As shown in FIG. 6, in some aspects, process 600 may include receiving, from a second UE, an IUC message comprising an indication of a first sidelink resource, of a set of sidelink resources, corresponding to a transmission by the second UE (block 610). For example, the first UE (e.g., using communication manager 1208 and/or reception component 1202, depicted in FIG. 12) may receive, from a second UE, an IUC message comprising an indication of a first sidelink resource, of a set of sidelink resources, corresponding to a transmission by the second UE, as described above. The first sidelink resource may correspond to the transmission based at least in part on the second UE selecting the first sidelink resource for the transmission and/or based at least in part on the second UE reserving the first sidelink resource by transmitting an indication of the first sidelink resource (e.g., the IUC message indicated above). The first sidelink resource may be associated with a first subset of the set of sidelink resources, where the first subset comprises a set of non-preferred resources. The set of non-preferred resources also may include any resources reserved by any other UEs.

In some aspects, the first UE may determine a second subset of the set of sidelink resources. The second subset may be a set of candidate resources. The set of candidate resources may include resources of the set of sidelink resources that are not included in the set of non-preferred resources.

As further shown in FIG. 6, in some aspects, process 600 may include transmitting a sidelink communication using a second sidelink resource, of a subset of candidate resources of the set of candidate resources, wherein the subset of candidate resources is based at least in part on the indication of the first sidelink resource and a communication relationship between the first UE and the second UE (block 620). For example, the UE (e.g., using communication manager 1208 and/or transmission component 1204, depicted in FIG. 12) may transmit a sidelink communication using a second sidelink resource, of a subset of candidate resources of the set of candidate resources, wherein the subset of candidate resources is based at least in part on the indication of the first sidelink resource and a communication relationship between the first UE and the second UE, as described above.

Process 600 may include additional aspects, such as any single aspect or any combination of aspects described below and/or in connection with one or more other processes described elsewhere herein.

In some aspects, the indication of the first sidelink resource comprises a specified resource indication value of an ordered set of resource indication values, the ordered set of resource indication values comprising at least one of a TRIV or an FRIV. In some aspects, the specified resource indication value corresponds to a first subset of resource indication values of the ordered set of resource indication values. In some aspects, the specified resource indication value comprises a full-bandwidth indication value corresponding to an entire available bandwidth in a reserved time resource. In some aspects, a number of resource indication values in the first subset of resource indication values is specified by a wireless communication standard.

In some aspects, process 600 includes receiving a configuration message that configures a number of resource indication values in the first subset of resource indication values. In some aspects, process 600 includes receiving a first stage sidelink control message comprising an indication of a number of resource indication values in the first subset of resource indication values. In some aspects, the indication of the number of resource indication values in the first subset of resource indication values comprises at least one reserved bit. In some aspects, the at least one reserved bit comprises only one bit, the method further comprising receiving a configuration message that indicates activation of a configuration of the at least one reserved bit to be used as the indication of the number of resource indication values in the first subset of resource indication values. In some aspects, the ordered set of resource indication values comprises an indication of a full-slot sidelink resource reserved by a third UE, and the indication of the full-slot sidelink resource comprises an indication of two half-slot reserved sidelink resources.

In some aspects, the specified resource indication value corresponds to a first subset of resource indication values of the ordered set of resource indication values, wherein the ordered set of resource indication values comprises an indication of a full-slot sidelink resource reserved by a third UE, and the indication of the full-slot sidelink resource is included in a second subset of resource indication values of the ordered set of resource indication values. In some aspects, the ordered set of resource indication values comprises an indication of a full-slot sidelink resource reserved by a third UE, and the indication of the full-slot sidelink resource comprises a resource indication value following a first non-full-slot resource indication value.

In some aspects, the first UE is a receiving UE of the transmission by the second UE, and the subset of candidate sidelink resources excludes resources corresponding to one or more slots associated with the first sidelink resource based at least in part on the UE being a receiver UE of the transmission by the second UE. In some aspects, the first UE is not a receiving UE of the transmission by the second UE, and the subset of candidate sidelink resources is the set of candidate resources, based at least in part on the first UE not being a receiving UE of the transmission by the second UE. In some aspects, the indication of the first sidelink resource comprises a full-bandwidth indication corresponding to an entire available bandwidth in a reserved time resource. In some aspects, the first UE is a receiving UE of the transmission by the second UE, wherein the subset of candidate sidelink resources excludes all resources corresponding to the first time resource. In some aspects, the first UE is not a receiver UE of the transmission by the second UE, and the subset of candidate sidelink resources is the set of candidate resources. In some aspects, the selected sidelink resource comprises a frequency resource having a bandwidth that is less than the entire available bandwidth.

In some aspects, the IUC message comprises the indication of the first sidelink resource based at least in part on the IUC message not being multiplexed with data. In some aspects, the IUC message is multiplexed with data, wherein the first UE is a receiving UE of the transmission by the second UE, and the subset of candidate sidelink resources excludes all resources associated with a slot corresponding to the first sidelink resource indicated in a first stage sidelink control information message.

In some aspects, process 600 includes receiving a configuration message comprising a configuration parameter having a first value or a second value, wherein the first value indicates that a set of sidelink resources to be indicated in the IUC message is the set of preferred sidelink resources, and the second value indicates that the set of sidelink resources to be indicated in the IUC message is the set of non-preferred sidelink resources. In some aspects, if the configuration parameter has the first value, the IUC message includes a differentiation of resources reserved by the second UE from resources reserved by a third UE, and process 600 includes excluding, from the subset of candidate resources, a slot corresponding to the resources reserved by the second UE if the first UE is a receiving UE of the transmission from the second UE. Process 600 includes excluding the resources indicated in the IUC if the first UE is not a receiving UE of the transmission from the second UE

If the parameter has the second value, the IUC message does not include a differentiation of resources reserved by the second UE from resources reserved by a third UE. In some aspects, process 600 includes excluding the resources indicated in the IUC message based at least in part on the configuration parameter having the second value. In some aspects, the IUC message comprises only the indication of the reserved sidelink resource based at least in part on the IUC message not being multiplexed with data.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a first UE, in accordance with the present disclosure. Example process 700 is an example where the first UE (e.g., the UE-B 404) performs operations associated with avoidance of half duplex loss in sidelink communication.

As shown in FIG. 7, in some aspects, process 700 may include receiving, from a second UE, an indication communication comprising: a first sidelink resource indication that indicates a first sidelink resource, of a set of sidelink resources, for a transmission by the second UE; and a second sidelink resource indication that indicates the first sidelink resource (block 710). For example, the first UE (e.g., using communication manager 1208 and/or reception component 1202, depicted in FIG. 12) may receive, from a second UE, an indication communication comprising: a first sidelink resource indication that indicates a first sidelink resource, of a set of sidelink resources, for a transmission by the second UE; and a second sidelink resource indication that indicates the reserved sidelink resource, as described above.

As further shown in FIG. 7, in some aspects, process 700 may include transmitting a sidelink communication using a second sidelink resource, of a subset of candidate resources of the set of sidelink resources, based at least in part on the indication communication and a communication relationship between the first UE and the second UE (block 720). For example, the first UE (e.g., using communication manager 1208 and/or transmission component 1204, depicted in FIG. 12) may transmit a sidelink communication using a second sidelink resource, of a subset of candidate resources of the set of sidelink resources, based at least in part on the indication communication and a communication relationship between the first UE and the second UE, as described above.

Process 700 may include additional aspects, such as any single aspect or any combination of aspects described below and/or in connection with one or more other processes described elsewhere herein.

In some aspects, the indication communication comprises a MAC CE or a second stage SCI message. In some aspects, only one of the first sidelink resource indication or the second sidelink resource indication indicates a plurality of additional sidelink resources, and the plurality of additional sidelink resources corresponds to a resource reservation by a third UE. In some aspects, the subset of candidate sidelink resources excludes the first sidelink resource based at least in part on the first reserved sidelink resource indication comprising an indication, corresponding to a slot, of a first frequency resource having a first bandwidth that is less than an entire available bandwidth, and the second reserved sidelink resource indication comprising an indication, corresponding to the slot, of a second frequency resource having a second bandwidth that is the entire available bandwidth. In some aspects, the indication communication comprises an IUC message, and the IUC message comprises the first sidelink resource indication and the second sidelink resource indication based at least in part on the IUC message not being multiplexed with data.

In some aspects, the first UE is not a receiving UE of the transmission by the second UE, and the subset of candidate resources is the set of candidate resources, based at least in part on the first UE not being a receiving UE of the transmission by the second UE. In some aspects, at least one of the first sidelink resource indication or the second sidelink resource indication comprises a full-bandwidth indication corresponding to an entire available bandwidth in a reserved time resource associated with the first sidelink resource. In some aspects, the first UE is a receiving UE of the transmission by the second UE, wherein the subset of candidate sidelink resources excludes all resources corresponding to the reserved time resource. In some aspects, the first UE is not a receiving UE of the transmission by the second UE, and the subset of candidate resources is the set of candidate resources.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a first UE, in accordance with the present disclosure. Example process 800 is an example where the first UE (e.g., the UE-B 404) performs operations associated with avoidance of half duplex loss in sidelink communication.

As shown in FIG. 8, in some aspects, process 800 may include receiving, from a second UE, an IUC message comprising a first sidelink resource indication that indicates a first sidelink resource, of a set of sidelink resources, for a transmission by the second UE, where the first sidelink resource is associated with a first subset of the set of sidelink resources, wherein the first subset comprises a set of non-preferred resources, and where a second subset of the set of sidelink resources comprises a set of candidate resources (block 810). For example, the first UE (e.g., using communication manager 1208 and/or reception component 1202, depicted in FIG. 12) may receive, from a second UE, an IUC message comprising a first sidelink resource indication that indicates a first sidelink resource, of a set of non-preferred sidelink resources, for a transmission by the second UE, as described above.

As further shown in FIG. 8, in some aspects, process 800 may include receiving, from the second UE, a sidelink control communication comprising a second sidelink resource indication that indicates at least one of a slot associated with the first sidelink resource or a first subchannel associated with the first sidelink resource (block 820). For example, the first UE (e.g., using communication manager 1208 and/or reception component 1202, depicted in FIG. 12) may receive, from the second UE, a sidelink control communication comprising a second sidelink resource indication that indicates at least one of a slot associated with the first sidelink resource or a first subchannel associated with the first sidelink resource, as described above.

As further shown in FIG. 8, in some aspects, process 800 may include transmitting a sidelink communication using a second sidelink resource, of a subset of candidate resources of the set of candidate resources, based at least in part on the first sidelink resource indication and a communication relationship between the first UE and the second UE (block 830). For example, the first UE (e.g., using communication manager 1208 and/or transmission component 1204, depicted in FIG. 12) may transmit a sidelink communication using a second sidelink resource, of a subset of candidate resources of the set of candidate resources, based at least in part on the first sidelink resource indication and a communication relationship between the first UE and the second UE, as described above.

Process 800 may include additional aspects, such as any single aspect or any combination of aspects described below and/or in connection with one or more other processes described elsewhere herein.

In some aspects, the second reserved sidelink resource indication indicates the slot associated with the first sidelink resource and the first subchannel associated with the first sidelink resource. In some aspects, the sidelink control communication comprises an SCI-1 message. In some aspects, the SCI-1 message comprises a future resource field, and the second sidelink resource indication comprises a value of the future resource field. In some aspects, the second sidelink resource indication indicates the slot associated with the first sidelink resource.

In some aspects, the sidelink control communication comprises an SCI-2 message. In some aspects, the SCI-2 message comprises a dedicated field, and the second sidelink resource indication comprises a value of the dedicated field. In some aspects, the first UE is a receiving UE of the transmission by the second UE, and the subset of candidate resources excludes all sidelink resources corresponding to a slot associated with the first sidelink resource. In some aspects, the first UE is not a receiving UE of the transmission by the second UE, and the subset of candidate resources is the set of candidate resources. In some aspects, the IUC message comprises the first sidelink resource indication and the sidelink control communication comprises the second sidelink resource indication based at least in part on the IUC message not being multiplexed with data.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a first UE, in accordance with the present disclosure. Example process 900 is an example where the first UE (e.g., UE-A 402) performs operations associated with avoidance of half duplex loss in sidelink communication.

As shown in FIG. 9, in some aspects, process 900 may include determining a first sidelink resource, of a set of sidelink resources, corresponding to a transmission by the first UE (block 910). For example, the first UE (e.g., using communication manager 1208 and/or determination component 1210, depicted in FIG. 12) may determine a first sidelink resource, of a set of sidelink resources, corresponding to a transmission by the first UE, as described above.

As further shown in FIG. 9, in some aspects, process 900 may include transmitting, to a second UE, an IUC message comprising an indication of the first sidelink resource, where the first sidelink resource is associated with a first subset of the set of sidelink resources, the first subset comprising a set of non-preferred resources (block 920). For example, the first UE (e.g., using communication manager 1208 and/or transmission component 1204, depicted in FIG. 12) may transmit, to a second UE, an IUC message comprising an indication of the first sidelink resource, as described above.

Process 900 may include additional aspects, such as any single aspect or any combination of aspects described below and/or in connection with one or more other processes described elsewhere herein.

In some aspects, the indication of the first sidelink resource comprises a specified resource indication value of an ordered set of resource indication values, the ordered set of resource indication values comprising at least one of a TRIV or an FRIV. In some aspects, the specified resource indication value corresponds to a first subset of resource indication values in the ordered set of resource indication values. In some aspects, the specified resource indication value comprises a full-bandwidth indication value corresponding to an entire available bandwidth in a reserved time resource associated with the first sidelink resource. In some aspects, a number of resource indication values in the first subset of resource indication values is specified by a wireless communication standard.

In some aspects, process 900 includes transmitting a configuration message that configures a number of resource indication values in the first subset of resource indication values. In some aspects, process 900 includes transmitting a first stage sidelink control message comprising an indication of a number of resource indication values in the first subset of resource indication values. In some aspects, the indication of the number of resource indication values in the first subset of resource indication values comprises at least one reserved bit. In some aspects, the at least one reserved bit comprises only one bit, the method further comprising transmitting a configuration message that indicates activation of a configuration of the at least one reserved bit to be used as the indication of the number of resource indication values in the first subset of resource indication values.

In some aspects, the ordered set of resource indication values comprises an indication of a full-slot sidelink resource reserved by a third UE, and the indication of the full-slot sidelink resource comprises an indication of two half-slot reserved candidate sidelink resources. In some aspects, the specified resource indication value corresponds to a first subset of resource indication values of the ordered set of resource indication values, wherein the ordered set of resource indication values comprises an indication of a full-slot sidelink resource reserved by a third UE, and the indication of the full-slot sidelink resource is included in a second subset of resource indication values of the ordered set of resource indication values.

In some aspects, the ordered set of resource indication values comprises an indication of a full-slot sidelink resource reserved by a third UE, and the indication of the full-slot sidelink resource comprises a resource indication value following a first non-full-slot resource indication value. In some aspects, the indication of the reserved sidelink resource comprises a full-bandwidth indication corresponding to an entire available bandwidth in a reserved time resource.

In some aspects, process 600 includes transmitting a configuration message comprising a configuration parameter having a first value or a second value, wherein the first value indicates that a set of sidelink resources to be indicated in the IUC message is the set of preferred sidelink resources, and the second value indicates that the set of sidelink resources to be indicated in the IUC message is the set of non-preferred sidelink resources. In some aspects, if the configuration parameter has the first value, the IUC message includes a differentiation of resources reserved by the second UE from resources reserved by a third UE, and the subset of candidate resources excludes a slot corresponding to the resources reserved by the second UE if the first UE is a receiving UE of the transmission from the second UE. The subset of candidate resources excludes the resources indicated in the IUC if the first UE is not a receiving UE of the transmission from the second UE

If the parameter has the second value, the IUC message does not include a differentiation of resources reserved by the second UE from resources reserved by a third UE. In some aspects, the subset of candidate resources excludes the resources indicated in the IUC message based at least in part on the configuration parameter having the second value. In some aspects, the IUC message comprises only the indication of the reserved sidelink resource based at least in part on the IUC message not being multiplexed with data.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a first UE, in accordance with the present disclosure. Example process 1000 is an example where the first UE (e.g., UE-A 402) performs operations associated with avoidance of half duplex loss in sidelink communication.

As shown in FIG. 10, in some aspects, process 1000 may include determining a first sidelink resource, of a set of sidelink resources, corresponding to a transmission by the first UE (block 1010). For example, the UE (e.g., using communication manager 1208 and/or determination component 1210, depicted in FIG. 12) may determine a first sidelink resource, of a set of sidelink resources, corresponding to a transmission by the first UE, as described above.

As further shown in FIG. 10, in some aspects, process 1000 may include transmitting an indication communication comprising: a first sidelink resource indication that indicates the first sidelink resource; and a second sidelink resource indication that indicates the first sidelink resource (block 1020). For example, the first UE, where the first sidelink resource is associated with a first subset of the set of sidelink resources, the first subset comprising a set of non-preferred resources (e.g., using communication manager 1208 and/or transmission component 1204, depicted in FIG. 12) may transmit an indication communication comprising: a first sidelink resource indication that indicates the first sidelink resource; and a second sidelink resource indication that indicates the first sidelink resource, as described above.

Process 1000 may include additional aspects, such as any single aspect or any combination of aspects described below and/or in connection with one or more other processes described elsewhere herein.

In some aspects, the indication communication comprises MAC CE or a second stage sidelink control information message. In some aspects, only one of the first sidelink resource indication or the second sidelink resource indication indicates a plurality of additional sidelink resources, and the plurality of additional reserved sidelink resources corresponds to a resource reservation by a third UE.

In some aspects, the communication comprises an IUC coordination message, and the IUC message comprises the first sidelink resource indication and the second sidelink resource indication based at least in part on the IUC message not being multiplexed with data. In some aspects, at least one of the first sidelink resource indication or the second sidelink resource indication comprises a full-bandwidth indication corresponding to an entire available bandwidth in a reserved time resource associated with the first sidelink resource.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a first UE, in accordance with the present disclosure. Example process 1100 is an example where the first UE (e.g., UE-A 402) performs operations associated with avoidance of half duplex loss in sidelink communication.

As shown in FIG. 11, in some aspects, process 1100 may include determining a first sidelink resource, of a set of sidelink resources, corresponding to a transmission by the first UE (block 1110). For example, the first UE (e.g., using communication manager 1208 and/or determination component 1210, depicted in FIG. 12) may determine a first sidelink resource, of a set of sidelink resources, corresponding to a transmission by the first UE, as described above.

As further shown in FIG. 11, in some aspects, process 1100 may include transmitting, to a second UE, an IUC message comprising a first sidelink resource indication that indicates the first sidelink resource, where the first sidelink resource is associated with a first subset of the set of sidelink resources, the first subset comprising a set of non-preferred resources (block 1120). For example, the first UE (e.g., using communication manager 1208 and/or transmission component 1204, depicted in FIG. 12) may transmit, to a second UE, an IUC message comprising a first sidelink resource indication that indicates the first sidelink resource, as described above.

As further shown in FIG. 11, in some aspects, process 1100 may include transmitting, to the second UE, a sidelink control communication comprising a second sidelink resource indication that indicates at least one of a slot associated with the first sidelink resource or a first subchannel associated with the first sidelink resource (block 1130). For example, the first UE (e.g., using communication manager 1208 and/or transmission component 1204, depicted in FIG. 12) may transmit, to the second UE, a sidelink control communication comprising a second sidelink resource indication that indicates at least one of a slot associated with the reserved sidelink resource or a first subchannel associated with the sidelink resource, as described above.

Process 1100 may include additional aspects, such as any single aspect or any combination of aspects described below and/or in connection with one or more other processes described elsewhere herein. In some aspects, the second reserved sidelink resource indication indicates the slot associated with the reserved sidelink resource and the first subchannel associated with the reserved sidelink resource.

In some aspects, the sidelink control communication comprises an SCS-1 message. In some aspects, the SCI-1 message comprises a future resource field, and the second sidelink resource indication comprises a value of the future resource field. In some aspects, the second sidelink resource indication indicates the slot associated with the first sidelink resource.

In some aspects, the sidelink control communication comprises an SCI-2 message. In some aspects, the SCI-2 message comprises a dedicated field, and the second sidelink resource indication comprises a value of the dedicated field. In some aspects, the IUC message comprises the first sidelink resource indication and the sidelink control communication comprises the second sidelink resource indication based at least in part on the IUC message not being multiplexed with data.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a network node, or another wireless communication device) using the reception component 1202 and the transmission component 1204. As further shown, the apparatus 1200 may include a communication manager 1208. The communication manager 1208 may include a determination component 1210.

In some aspects, the apparatus 1200 may be configured to perform one or more operations described herein in connection with FIGS. 4 and 5. Additionally, or alternatively, the apparatus 1200 may be configured to perform one or more processes described herein, such as process 600 of FIG. 6, process 700 of FIG. 7, process 800 of FIG. 8, process 900 of FIG. 9, process 1000 of FIG. 10, process 1100 of FIG. 11, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The reception component 1202 may receive, from a second UE, an IUC message comprising an indication of a first sidelink resource, of a set of sidelink resources, corresponding to a transmission by the second UE. The transmission component 1204 may transmit a sidelink communication using a second sidelink resource, of a subset of candidate resources of a set of candidate resources, based at least in part on the indication of the first sidelink resource and a communication relationship between the first UE and the second UE.

The reception component 1202 may receive a configuration message that configures a number of resource indication values in the first subset of resource indication values. The reception component 1202 may receive a first stage sidelink control message comprising an indication of a number of resource indication values in the first subset of resource indication values. The reception component 1202 may receive a configuration message comprising a configuration parameter having a first value or a second value, wherein the first value indicates that the set of sidelink resources is a set of preferred sidelink resources, and the second value indicates that the set of sidelink resources is a set of non-preferred sidelink resources, and the subset of candidate sidelink resources excludes all sidelink resources in a slot associated with the reserved sidelink resource based at least in part on the configuration message.

The reception component 1202 may receive, from a second UE, an indication communication comprising a first sidelink resource indication that indicates a first sidelink resource, of a set of sidelink resources, for a transmission by the second UE; and a second sidelink resource indication that indicates the first sidelink resource. The transmission component 1204 may transmit a sidelink communication using a second sidelink resource, of a subset of candidate sidelink resources of a set of candidate sidelink resources, based at least in part on the indication communication and a communication relationship between the first UE and the second UE.

The reception component 1202 may receive, from a second UE, an IUC message comprising a first sidelink resource indication that indicates a first sidelink resource, of a set of sidelink resources, corresponding to a transmission by the second UE. The reception component 1202 may receive, from the second UE, a sidelink control communication comprising a second sidelink resource indication that indicates at least one of a slot associated with the first sidelink resource or a first subchannel associated with the first sidelink resource. The transmission component 1204 may transmit a sidelink communication using a second sidelink resource, of a subset of candidate sidelink resources of a set of candidate resources, based at least in part on the first reserved sidelink resource indication and a communication relationship between the first UE and the second UE.

The communication manager 1208 and/or the determination component 1210 may determine a first sidelink resource, of a set of sidelink resources, corresponding to a transmission by the first UE. In some aspects, the communication manager 1208 may be, be similar to, include, or be included in the communication manager 140 depicted in FIGS. 1 and 2. In some aspects, the communication manager 1208 may include one or more antennas, a modem, a controller/processor, a memory, or a combination thereof, of the UE described in connection with FIG. 2. In some aspects, the communication manager 1208 may include the reception component 1202 and/or the transmission component 1204.

The transmission component 1204 may transmit, to a second UE, an IUC message comprising an indication of the first sidelink resource. The transmission component 1204 may transmit a configuration message that configures a number of resource indication values in the first subset of resource indication values. The transmission component 1204 may transmit a first stage sidelink control message comprising an indication of a number of resource indication values in the first subset of resource indication values. The transmission component 1204 may transmit a configuration message comprising a configuration parameter having a first value or a second value, wherein the first value indicates that the set of sidelink resources is a set of preferred sidelink resources, and the second value indicates that the set of sidelink resources is a set of non-preferred sidelink resources.

The communication manager 1208 and/or the determination component 1210 may determine a first sidelink resource, of a set of sidelink resources, corresponding to a transmission by the first UE. The transmission component 1204 may transmit an indication communication comprising a first reserved sidelink resource indication that indicates the reserved sidelink resource; and a second reserved sidelink resource indication that indicates the reserved sidelink resource.

The communication manager 1208 and/or the determination component 1210 may determine a reserved sidelink resource, of a set of non-preferred sidelink resources, for a transmission by the first UE. The transmission component 1204 may transmit, to a second UE, an IUC message comprising a first sidelink resource indication that indicates the first sidelink resource. The transmission component 1204 may transmit, to the second UE, a sidelink control communication comprising a second sidelink resource indication that indicates at least one of a slot associated with the first sidelink resource or a first subchannel associated with the first sidelink resource.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a first user equipment (UE), comprising: receiving, from a second UE, an inter-UE coordination (IUC) message comprising an indication of a first sidelink resource, of a set of sidelink resources, corresponding to a transmission by the second UE, wherein the first sidelink resource is associated with a first subset of the set of sidelink resources, wherein the first subset comprises a set of non-preferred resources, and wherein a second subset of the set of sidelink resources comprises a set of candidate resources; and transmitting a sidelink communication using a second sidelink resource, of a subset of candidate resources of the set of candidate resources, wherein the subset of candidate resources is based at least in part on the indication of the first sidelink resource and a communication relationship between the first UE and the second UE.

Aspect 2: The method of Aspect 1, wherein the indication of the first sidelink resource comprises a specified resource indication value of an ordered set of resource indication values, the ordered set of resource indication values comprising at least one of a time resource indication value (TRIV) or a frequency resource indication value (FRIV).

Aspect 3: The method of Aspect 2, wherein the specified resource indication value corresponds to a first subset of resource indication values of the ordered set of resource indication values.

Aspect 4: The method of Aspect 3, wherein the specified resource indication value comprises a full-bandwidth indication value corresponding to an entire available bandwidth in a reserved time resource associated with the first sidelink resource.

Aspect 5: The method of either of Aspects 3 or 4, wherein a number of resource indication values in the first subset of resource indication values is specified by a wireless communication standard.

Aspect 6: The method of any of Aspects 3-5, further comprising receiving a configuration message that configures a number of resource indication values in the first subset of resource indication values.

Aspect 7: The method of any of Aspects 3-6, further comprising receiving a first stage sidelink control message comprising an indication of a number of resource indication values in the first subset of resource indication values.

Aspect 8: The method of Aspect 7, wherein the indication of the number of resource indication values in the first subset of resource indication values comprises at least one reserved bit.

Aspect 9: The method of Aspect 8, wherein the at least one reserved bit comprises only one bit, the method further comprising receiving a configuration message that indicates activation of a configuration of the at least one reserved bit to be used as the indication of the number of resource indication values in the first subset of resource indication values.

Aspect 10: The method of any of Aspects 2-9, wherein the ordered set of resource indication values comprises an indication of a full-slot sidelink resource reserved by a third UE, and wherein the indication of the full-slot sidelink resource comprises an indication of two half-slot reserved sidelink resources.

Aspect 11: The method of any of Aspects 2-10, wherein the specified resource indication value corresponds to a first subset of resource indication values of the ordered set of resource indication values, wherein the ordered set of resource indication values comprises an indication of a full-slot sidelink resource reserved by a third UE, and wherein the indication of the full-slot sidelink resource is included in a second subset of resource indication values of the ordered set of resource indication values.

Aspect 12: The method of any of Aspects 2-11, wherein the ordered set of resource indication values comprises an indication of a full-slot sidelink resource reserved by a third UE, and wherein the indication of the full-slot sidelink resource comprises a resource indication value following a first non-full-slot resource indication value.

Aspect 13: The method of any of Aspects 1-12, wherein the first UE is a receiving UE of the transmission by the second UE, and wherein the subset of candidate resources excludes resources corresponding to one or more slots associated with the first sidelink resource based at least in part on the UE being a receiver UE of the transmission by the second UE.

Aspect 14: The method of any of Aspects 1-12, wherein the first UE is not a receiving UE of the transmission by the second UE, and wherein the subset of candidate resources is the set of candidate resources, based at least in part on the first UE not being a receiving UE of the transmission by the second UE.

Aspect 15: The method of any of Aspects 1-14, wherein the indication of the first sidelink resource comprises a full-bandwidth indication corresponding to an entire available bandwidth in a reserved time resource associated with the first sidelink resource.

Aspect 16: The method of Aspect 15, wherein the first UE is a receiving UE of the transmission by the second UE, wherein the subset of candidate resources excludes all resources corresponding to the reserved time resource.

Aspect 17: The method of either of Aspects 15 or 16, wherein the first UE is not a receiver UE of the transmission by the second UE, and wherein the subset of candidate resources is the set of candidate resources.

Aspect 18: The method of Aspect 17, wherein the second sidelink resource comprises a frequency resource having a bandwidth that is less than the entire available bandwidth.

Aspect 19: The method of any of Aspects 1-18, wherein the IUC message comprises the indication of the first sidelink resource based at least in part on the IUC message not being multiplexed with data.

Aspect 20: The method of any of Aspects 1-18, wherein the IUC message is multiplexed with data, wherein the first UE is a receiving UE of the transmission by the second UE, and wherein the subset of candidate resources excludes all resources associated with a slot corresponding to the first sidelink resource indicated in a first stage sidelink control information message.

Aspect 21: The method of any of Aspects 1-20, further comprising receiving a configuration message comprising a configuration parameter having a first value or a second value, wherein the first value indicates that a set of sidelink resources indicated by the IUC message is a set of non-preferred sidelink resources.

Aspect 22: The method of Aspect 21, wherein the IUC message includes a differentiation of resources reserved by the second UE from resources reserved by a third UE based at least in part on the configuration parameter having the first value, and wherein the subset of candidate resources excludes a slot corresponding to the resources reserved by the second UE based at least in part on the first UE being a receiving UE of the transmission from the second UE or excludes the set of sidelink resources indicated by the IUC message based at least in part on the first UE not being a receiving UE of the transmission from the second UE.

Aspect 23: The method of Aspect 21, wherein the IUC message does not include a differentiation of resources reserved by the second UE from resources reserved by a third UE based at least in part on the configuration parameter having the second value.

Aspect 24: The method of any of Aspects 1-23, further comprising determining the second subset based at least in part on the first subset.

Aspect 25: A method of wireless communication performed by a first user equipment (UE), comprising: receiving, from a second UE, an indication communication comprising: a first sidelink resource indication that indicates a first sidelink resource, of a set of sidelink resources, corresponding to a transmission by the second UE, wherein the first sidelink resource is associated with a first subset of the set of sidelink resources, wherein the first subset comprises a set of non-preferred resources, and wherein a second subset of the set of sidelink resources comprises a set of candidate resources; and a second sidelink resource indication that indicates the first sidelink resource; and transmitting a sidelink communication using a second sidelink resource, of a subset of candidate resources of the set of candidate resources, wherein the subset of candidate resources is based at least in part on the indication communication and a communication relationship between the first UE and the second UE.

Aspect 26: The method of Aspect 25, wherein the indication communication comprises a medium access control (MAC) control element (MAC CE) or a second stage sidelink control information message.

Aspect 27: The method of either of Aspects 25 or 26, wherein only one of the first reserved sidelink resource indication or the second reserved sidelink resource indication indicates a plurality of additional sidelink resources, and wherein the plurality of additional sidelink resources corresponds to a resource reservation associated with a third UE.

Aspect 28: The method of any of Aspects 25-27, wherein the subset of candidate resources excludes the first sidelink resource based at least in part on: the first reserved sidelink resource indication comprising an indication, corresponding to a slot, of a first frequency resource having a first bandwidth that is less than an entire available bandwidth; and the second reserved sidelink resource indication comprising an indication, corresponding to the slot, of a second frequency resource having a second bandwidth that is the entire available bandwidth.

Aspect 29: The method of any of Aspects 25-28, wherein the indication communication comprises an inter-UE coordination (IUC) message, and wherein the IUC message comprises the first reserved sidelink resource indication and the second reserved sidelink resource indication based at least in part on the IUC message not being multiplexed with data.

Aspect 30: The method of any of Aspects 25-29, wherein the first UE is not a receiving UE of the transmission by the second UE, and wherein the subset of candidate resources is the set of candidate resources, based at least in part on the first UE not being a receiving UE of the transmission by the second UE.

Aspect 31: The method of any of Aspects 25-29, wherein at least one of the first reserved sidelink resource indication or the second reserved sidelink resource indication comprises a full-bandwidth indication corresponding to an entire available bandwidth in a reserved time resource associated with the first sidelink resource.

Aspect 32: The method of Aspect 31, wherein the first UE is a receiving UE of the transmission by the second UE, and wherein the subset of candidate resources excludes all resources corresponding to the reserved time resource based at least in part on the first UE being a receiving UE of the transmission by the second UE.

Aspect 33: The method of any of Aspects 25-32, further comprising determining the second subset based at least in part on the first subset.

Aspect 34: A method of wireless communication performed by a first user equipment (UE), comprising: receiving, from a second UE, an inter-UE coordination (IUC) message comprising a first sidelink resource indication that indicates a first sidelink resource, of a set of sidelink resources, corresponding to a transmission by the second UE, wherein the first sidelink resource is associated with a first subset of the set of sidelink resources, wherein the first subset comprises a set of non-preferred resources, and wherein a second subset of the set of sidelink resources comprises a set of candidate resources; receiving, from the second UE, a sidelink control communication comprising a second sidelink resource indication that indicates at least one of a slot associated with the first sidelink resource or a first subchannel associated with the first sidelink resource; and transmitting a sidelink communication using a second sidelink resource, of a subset of candidate resources of the set of candidate resources, wherein the subset of candidate resources is based at least in part on the first sidelink resource indication and a communication relationship between the first UE and the second UE.

Aspect 35: The method of Aspect 34, wherein the second sidelink resource indication indicates the slot associated with the first sidelink resource and the first subchannel associated with the first sidelink resource.

Aspect 36: The method of either of Aspects 34 or 35, wherein the sidelink control communication comprises a first stage sidelink control information (SCI-1) message.

Aspect 37: The method of Aspect 36, wherein the SCI-1 message comprises a future resource field, and wherein the second sidelink resource indication comprises a value of the future resource field.

Aspect 38: The method of Aspect 34, wherein the second sidelink resource indication indicates the slot associated with the first sidelink resource.

Aspect 39: The method of Aspect 34, wherein the sidelink control communication comprises a second stage sidelink control information (SCI-2) message.

Aspect 40: The method of Aspect 39, wherein the SCI-2 message comprises a dedicated field, and wherein the second sidelink resource indication comprises a value of the dedicated field.

Aspect 41: The method of any of Aspects 34-40, wherein the first UE is a receiving UE of the transmission by the second UE, and wherein the subset of candidate resources excludes all sidelink resources corresponding to a slot associated with the first sidelink resource based at least in part on the first UE being a receiving UE of the transmission by the second UE.

Aspect 42: The method of any of Aspects 34-40, wherein the first UE is not a receiving UE of the transmission by the second UE, and wherein the subset of candidate resources is the set of candidate resources based at least in part on the first UE not being a receiving UE of the transmission by the second UE.

Aspect 43: The method of any of Aspects 34-42, wherein the IUC message comprises the first sidelink resource indication and the sidelink control communication comprises the second sidelink resource indication based at least in part on the IUC message not being multiplexed with data.

Aspect 44: The method of any of Aspects 34-43, further comprising determining the second subset based at least in part on the first subset.

Aspect 45: A method of wireless communication performed by a first user equipment (UE), comprising: determining a first sidelink resource, of a set of sidelink resources, corresponding to a transmission by the first UE; and transmitting, to a second UE, an inter-UE coordination (IUC) message comprising an indication of the first sidelink resource, wherein the first sidelink resource is associated with a first subset of the set of sidelink resources, wherein the first subset comprises a set of non-preferred resources.

Aspect 46: The method of Aspect 45, wherein the indication of the first sidelink resource comprises a specified resource indication value of an ordered set of resource indication values, the ordered set of resource indication values comprising at least one of a time resource indication value (TRIV) or a frequency resource indication value (FRIV).

Aspect 47: The method of Aspect 46, wherein the specified resource indication value corresponds to a first subset of resource indication values in the ordered set of resource indication values.

Aspect 48: The method of Aspect 47, wherein the specified resource indication value comprises a full-bandwidth indication value corresponding to an entire available bandwidth in a reserved time resource associated with the first sidelink resource.

Aspect 49: The method of either of Aspects 47 or 48, wherein a number of resource indication values in the first subset of resource indication values is specified by a wireless communication standard.

Aspect 50: The method of any of Aspects 47-49, further comprising transmitting a configuration message that configures a number of resource indication values in the first subset of resource indication values.

Aspect 51: The method of any of Aspects 47-50, further comprising transmitting a first stage sidelink control message comprising an indication of a number of resource indication values in the first subset of resource indication values.

Aspect 52: The method of Aspect 51, wherein the indication of the number of resource indication values in the first subset of resource indication values comprises at least one reserved bit.

Aspect 53: The method of Aspect 52, wherein the at least one reserved bit comprises only one bit, the method further comprising transmitting a configuration message that indicates activation of a configuration of the at least one reserved bit to be used as the indication of the number of resource indication values in the first subset of resource indication values.

Aspect 54: The method of any of Aspects 46-53, wherein the ordered set of resource indication values comprises an indication of a full-slot sidelink resource reserved by a third UE, and wherein the indication of the full-slot sidelink resource comprises an indication of two half-slot reserved candidate sidelink resources.

Aspect 55: The method of any of Aspects 46-54, wherein the specified resource indication value corresponds to a first subset of resource indication values of the ordered set of resource indication values, wherein the ordered set of resource indication values comprises an indication of a full-slot sidelink resource reserved by a third UE, and wherein the indication of the full-slot sidelink resource is included in a second subset of resource indication values of the ordered set of resource indication values.

Aspect 56: The method of any of Aspects 46-55, wherein the ordered set of resource indication values comprises an indication of a full-slot sidelink resource reserved by a third UE, and wherein the indication of the full-slot sidelink resource comprises a resource indication value following a first non-full-slot resource indication value.

Aspect 57: The method of any of Aspects 45-56, wherein the indication of the first sidelink resource comprises a full-bandwidth indication corresponding to an entire available bandwidth in a reserved time resource associated with the first sidelink resource.

Aspect 58: The method of any of Aspects 45-57, wherein the IUC message comprises the indication of the first sidelink resource based at least in part on the IUC message not being multiplexed with data.

Aspect 59: The method of any of Aspects 45-58, further comprising receiving a configuration message comprising a configuration parameter having a first value or a second value, wherein the first value indicates that a set of sidelink resources indicated by the IUC message is a set of non-preferred sidelink resources.

Aspect 60: The method of Aspect 59, wherein the IUC message includes a differentiation of resources reserved by the second UE from resources reserved by a third UE based at least in part on the configuration parameter having the first value.

Aspect 61: The method of Aspect 59, wherein the IUC message does not include a differentiation of resources reserved by the second UE from resources reserved by a third UE based at least in part on the configuration parameter having the second value.

Aspect 62: A method of wireless communication performed by a first user equipment (UE), comprising: determining a first sidelink resource, of a set of sidelink resources, corresponding to a transmission by the first UE; and transmitting an indication communication comprising: a first sidelink resource indication that indicates the first sidelink resource; and a second sidelink resource indication that indicates the first sidelink resource, wherein the first sidelink resource is associated with a first subset of the set of sidelink resources, wherein the first subset comprises a set of non-preferred resources.

Aspect 63: The method of Aspect 62, wherein the indication communication comprises a medium access control (MAC) control element (MAC CE) or a second stage sidelink control information message.

Aspect 64: The method of either of Aspects 62 or 63, wherein only one of the first sidelink resource indication or the second sidelink resource indication indicates a plurality of additional sidelink resources, and wherein the plurality of additional sidelink resources corresponds to a resource reservation associated with a third UE.

Aspect 65: The method of any of Aspects 62-64, wherein the communication comprises an inter-UE coordination (IUC) message, and wherein the IUC message comprises the first sidelink resource indication and the second sidelink resource indication based at least in part on the IUC message not being multiplexed with data.

Aspect 66: The method of any of Aspects 62-65, wherein at least one of the first sidelink resource indication or the second sidelink resource indication comprises a full-bandwidth indication corresponding to an entire available bandwidth in a reserved time resource associated with the first sidelink resource.

Aspect 67: A method of wireless communication performed by a first user equipment (UE), comprising: determining a first sidelink resource, of a set of sidelink resources, corresponding to a transmission by the first UE; transmitting, to a second UE, an inter-UE coordination (IUC) message comprising a first sidelink resource indication that indicates the first sidelink resource, wherein the first sidelink resource is associated with a first subset of the set of sidelink resources, wherein the first subset comprises a set of non-preferred resources; and transmitting, to the second UE, a sidelink control communication comprising a second sidelink resource indication that indicates at least one of a slot associated with the first sidelink resource or a first subchannel associated with the first sidelink resource.

Aspect 68: The method of Aspect 67, wherein the second sidelink resource indication indicates the slot associated with the first sidelink resource and the first subchannel associated with the first sidelink resource.

Aspect 69: The method of either of Aspects 67 or 68, wherein the sidelink control communication comprises a first stage sidelink control information (SCI-1) message.

Aspect 70: The method of Aspect 69, wherein the SCI-1 message comprises a future resource field, and wherein the second sidelink resource indication comprises a value of the future resource field.

Aspect 71: The method of any of Aspects 67-70, wherein the second sidelink resource indication indicates the slot associated with the first sidelink resource.

Aspect 72: The method of any of Aspects 67-71, wherein the sidelink control communication comprises a second stage sidelink control information (SCI-2) message.

Aspect 73: The method of Aspect 72, wherein the SCI-2 message comprises a dedicated field, and wherein the second sidelink resource indication comprises a value of the dedicated field.

Aspect 74: The method of any of Aspects 67-73, wherein the IUC message comprises the first sidelink resource indication and the sidelink control communication comprises the second sidelink resource indication based at least in part on the IUC message not being multiplexed with data.

Aspect 75: An apparatus for wireless communication at a device, comprising a processor; memory coupled with the processor; and instructions stored in the memory and executable by the processor to cause the apparatus to perform the method of one or more of Aspects 1-24.

Aspect 76: A device for wireless communication, comprising a memory and one or more processors coupled to the memory, the one or more processors configured to perform the method of one or more of Aspects 1-24.

Aspect 77: An apparatus for wireless communication, comprising at least one means for performing the method of one or more of Aspects 1-24.

Aspect 78: A non-transitory computer-readable medium storing code for wireless communication, the code comprising instructions executable by a processor to perform the method of one or more of Aspects 1-24.

Aspect 79: A non-transitory computer-readable medium storing a set of instructions for wireless communication, the set of instructions comprising one or more instructions that, when executed by one or more processors of a device, cause the device to perform the method of one or more of Aspects 1-24.

Aspect 80: An apparatus for wireless communication at a device, comprising a processor; memory coupled with the processor; and instructions stored in the memory and executable by the processor to cause the apparatus to perform the method of one or more of Aspects 25-33.

Aspect 81: A device for wireless communication, comprising a memory and one or more processors coupled to the memory, the one or more processors configured to perform the method of one or more of Aspects 25-33.

Aspect 82: An apparatus for wireless communication, comprising at least one means for performing the method of one or more of Aspects 25-33.

Aspect 83: A non-transitory computer-readable medium storing code for wireless communication, the code comprising instructions executable by a processor to perform the method of one or more of Aspects 25-33.

Aspect 84: A non-transitory computer-readable medium storing a set of instructions for wireless communication, the set of instructions comprising one or more instructions that, when executed by one or more processors of a device, cause the device to perform the method of one or more of Aspects 25-33.

Aspect 85: An apparatus for wireless communication at a device, comprising a processor; memory coupled with the processor; and instructions stored in the memory and executable by the processor to cause the apparatus to perform the method of one or more of Aspects 34-44.

Aspect 86: A device for wireless communication, comprising a memory and one or more processors coupled to the memory, the one or more processors configured to perform the method of one or more of Aspects 34-44.

Aspect 87: An apparatus for wireless communication, comprising at least one means for performing the method of one or more of Aspects 34-44.

Aspect 88: A non-transitory computer-readable medium storing code for wireless communication, the code comprising instructions executable by a processor to perform the method of one or more of Aspects 34-44.

Aspect 89: A non-transitory computer-readable medium storing a set of instructions for wireless communication, the set of instructions comprising one or more instructions that, when executed by one or more processors of a device, cause the device to perform the method of one or more of Aspects 34-44.

Aspect 90: An apparatus for wireless communication at a device, comprising a processor; memory coupled with the processor; and instructions stored in the memory and executable by the processor to cause the apparatus to perform the method of one or more of Aspects 45-61.

Aspect 91: A device for wireless communication, comprising a memory and one or more processors coupled to the memory, the one or more processors configured to perform the method of one or more of Aspects 45-61.

Aspect 92: An apparatus for wireless communication, comprising at least one means for performing the method of one or more of Aspects 45-61.

Aspect 93: A non-transitory computer-readable medium storing code for wireless communication, the code comprising instructions executable by a processor to perform the method of one or more of Aspects 45-61.

Aspect 94: A non-transitory computer-readable medium storing a set of instructions for wireless communication, the set of instructions comprising one or more instructions that, when executed by one or more processors of a device, cause the device to perform the method of one or more of Aspects 45-61.

Aspect 95: An apparatus for wireless communication at a device, comprising a processor; memory coupled with the processor; and instructions stored in the memory and executable by the processor to cause the apparatus to perform the method of one or more of Aspects 62-66.

Aspect 96: A device for wireless communication, comprising a memory and one or more processors coupled to the memory, the one or more processors configured to perform the method of one or more of Aspects 62-66.

Aspect 97: An apparatus for wireless communication, comprising at least one means for performing the method of one or more of Aspects 62-66.

Aspect 98: A non-transitory computer-readable medium storing code for wireless communication, the code comprising instructions executable by a processor to perform the method of one or more of Aspects 62-66.

Aspect 99: A non-transitory computer-readable medium storing a set of instructions for wireless communication, the set of instructions comprising one or more instructions that, when executed by one or more processors of a device, cause the device to perform the method of one or more of Aspects 62-66.

Aspect 100: An apparatus for wireless communication at a device, comprising a processor; memory coupled with the processor; and instructions stored in the memory and executable by the processor to cause the apparatus to perform the method of one or more of Aspects 67-74.

Aspect 101: A device for wireless communication, comprising a memory and one or more processors coupled to the memory, the one or more processors configured to perform the method of one or more of Aspects 67-74.

Aspect 102: An apparatus for wireless communication, comprising at least one means for performing the method of one or more of Aspects 67-74.

Aspect 103: A non-transitory computer-readable medium storing code for wireless communication, the code comprising instructions executable by a processor to perform the method of one or more of Aspects 67-74.

Aspect 104: A non-transitory computer-readable medium storing a set of instructions for wireless communication, the set of instructions comprising one or more instructions that, when executed by one or more processors of a device, cause the device to perform the method of one or more of Aspects 67-74.

The foregoing disclosure provides illustration and description but is not intended to be exhaustive or to limit the aspects to the precise forms disclosed. Modifications and variations may be made in light of the above disclosure or may be acquired from practice of the aspects.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first user equipment (UE) for wireless communication, comprising:
a memory; and
one or more processors, coupled to the memory, configured to:
determine a first sidelink resource, of a set of sidelink resources, corresponding to a transmission by the first UE; and
transmit, to a second UE, an inter-UE coordination (IUC) message comprising an indication of the first sidelink resource, wherein the first sidelink resource is associated with a first subset of the set of sidelink resources, wherein the first subset comprises a set of non-preferred resources.

2. The first UE of claim 1, wherein the indication of the first sidelink resource comprises a specified resource indication value of an ordered set of resource indication values, the ordered set of resource indication values comprising at least one of a time resource indication value (TRIV) or a frequency resource indication value (FRIV), and wherein the specified resource indication value corresponds to a first subset of resource indication values in the ordered set of resource indication values.

3. The first UE of claim 2, wherein the specified resource indication value comprises a full-bandwidth indication value corresponding to an entire available bandwidth in a reserved time resource associated with the first sidelink resource.

4. The first UE of claim 2, wherein a number of resource indication values in the first subset of resource indication values is specified by a wireless communication standard.

5. The first UE of claim 2, wherein the one or more processors are further configured to transmit a configuration message that configures a number of resource indication values in the first subset of resource indication values.

6. The first UE of claim 2, wherein the one or more processors are further configured to transmit a first stage sidelink control message comprising an indication of a number of resource indication values in the first subset of resource indication values.

7. The first UE of claim 6, wherein the indication of the number of resource indication values in the first subset of resource indication values comprises at least one reserved bit.

8. The first UE of claim 7, wherein the at least one reserved bit comprises only one bit, and wherein the one or more processors are further configured to transmit a configuration message that indicates activation of a configuration of the at least one reserved bit to be used as the indication of the number of resource indication values in the first subset of resource indication values.

9. The first UE of claim 2, wherein the ordered set of resource indication values comprises an indication of a full-slot sidelink resource reserved by a third UE, and wherein the indication of the full-slot sidelink resource comprises an indication of two half-slot reserved candidate sidelink resources.

10. The first UE of claim 2, wherein the specified resource indication value corresponds to a first subset of resource indication values of the ordered set of resource indication values, wherein the ordered set of resource indication values comprises an indication of a full-slot sidelink resource reserved by a third UE, and wherein the indication of the full-slot sidelink resource is included in a second subset of resource indication values of the ordered set of resource indication values.

11. The first UE of claim 2, wherein the ordered set of resource indication values comprises an indication of a full-slot sidelink resource reserved by a third UE, and wherein the indication of the full-slot sidelink resource comprises a resource indication value following a first non-full-slot resource indication value.

12. The first UE of claim 1, wherein the indication of the first sidelink resource comprises a full-bandwidth indication corresponding to an entire available bandwidth in a reserved time resource associated with the first sidelink resource.

13. The first UE of claim 1, wherein the IUC message comprises the indication of the first sidelink resource based at least in part on the IUC message not being multiplexed with data.

14. The first UE of claim 1, wherein the one or more processors are further configured to receive a configuration message comprising a configuration parameter having a first value or a second value, wherein the first value indicates that a set of sidelink resources indicated by the IUC message is a set of non-preferred sidelink resources.

15. The first UE of claim 14, wherein the IUC message includes a differentiation of resources reserved by the second UE from resources reserved by a third UE based at least in part on the configuration parameter having the first value.

16. The first UE of claim 14, wherein the IUC message does not include a differentiation of resources reserved by the second UE from resources reserved by a third UE based at least in part on the configuration parameter having the second value.

17. A first user equipment (UE) for wireless communication, comprising:
a memory; and
one or more processors, coupled to the memory, configured to:
determine a first sidelink resource, of a set of sidelink resources, corresponding to a transmission by the first UE; and
transmit an indication communication comprising:
a first sidelink resource indication that indicates the first sidelink resource; and
a second sidelink resource indication that indicates the first sidelink resource, wherein the first sidelink resource is associated with a first subset of the set of sidelink resources, wherein the first subset comprises a set of non-preferred resources.

18. The first UE of claim 17, wherein the indication communication comprises a medium access control (MAC) control element (MAC CE) or a second stage sidelink control information message.

19. The first UE of claim 17, wherein only one of the first sidelink resource indication or the second sidelink resource indication indicates a plurality of additional sidelink resources, and wherein the plurality of additional sidelink resources corresponds to a resource reservation associated with a third UE.

20. The first UE of claim 17, wherein the indication communication comprises an inter-UE coordination (IUC) message, and wherein the IUC message comprises the first sidelink resource indication and the second sidelink resource indication based at least in part on the IUC message not being multiplexed with data.

21. The first UE of claim 17, wherein at least one of the first sidelink resource indication or the second sidelink resource indication comprises a full-bandwidth indication corresponding to an entire available bandwidth in a reserved time resource associated with the first sidelink resource.

22. A first user equipment (UE) for wireless communication, comprising:
a memory; and
one or more processors, coupled to the memory, configured to:
determine a first sidelink resource, of a set of sidelink resources, corresponding to a transmission by the first UE;
transmit, to a second UE, an inter-UE coordination (IUC) message comprising a first sidelink resource indication that indicates the first sidelink resource, wherein the first sidelink resource is associated with a first subset of the set of sidelink resources, wherein the first subset comprises a set of non-preferred resources; and
transmit, to the second UE, a sidelink control communication comprising a second sidelink resource indication that indicates at least one of a slot associated with the first sidelink resource or a first subchannel associated with the first sidelink resource.

23. The first UE of claim 22, wherein the second sidelink resource indication indicates the slot associated with the first sidelink resource and the first subchannel associated with the first sidelink resource.

24. The first UE of claim 22, wherein the sidelink control communication comprises a first stage sidelink control information (SCI-1) message, and wherein the SCI-1 message comprises a future resource field, and wherein the second sidelink resource indication comprises a value of the future resource field.

25. The first UE of claim 22, wherein the second sidelink resource indication indicates the slot associated with the first sidelink resource.

26. The first UE of claim 22, wherein the sidelink control communication comprises a second stage sidelink control information (SCI-2) message, and wherein the SCI-2 message comprises a dedicated field, and wherein the second sidelink resource indication comprises a value of the dedicated field.

27. The first UE of claim 22, wherein the IUC message comprises the first sidelink resource indication and the sidelink control communication comprises the second sidelink resource indication based at least in part on the IUC message not being multiplexed with data.

28. A method of wireless communication performed by a first user equipment (UE), comprising:
determining a first sidelink resource, of a set of sidelink resources, corresponding to a transmission by the first UE; and
transmitting, to a second UE, an inter-UE coordination (IUC) message comprising an indication of the first sidelink resource, wherein the first sidelink resource is associated with a first subset of the set of sidelink resources, wherein the first subset comprises a set of non-preferred resources.

29. The method of claim 28, wherein the indication of the first sidelink resource comprises a specified resource indication value of an ordered set of resource indication values, the ordered set of resource indication values comprising at least one of a time resource indication value (TRIV) or a frequency resource indication value (FRIV), and wherein the specified resource indication value corresponds to a first subset of resource indication values in the ordered set of resource indication values.

30. The method of claim 28, wherein the indication of the first sidelink resource comprises a full-bandwidth indication corresponding to an entire available bandwidth in a reserved time resource associated with the first sidelink resource.
